(19) United States
(12) Patent Application Publication
(10) Pub. No.: US 2025/0071778 A1
(43) Pub. Date: Feb. 27, 2025

(54) COMPACT MAC-CE DESIGN FOR PAIRING A DOWNLINK TCI STATE AND AN UPLINK TCI STATE

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/719,182

(22) PCT Filed: Feb. 12, 2022
(86) PCT No.: PCT/CN2022/076111

§ 371 Date: Jun. 12, 2024

(51) Int. Cl. H04W 72/231; H04L 5/00

(52) U.S. Cl. CPC H04W 72/231; H04L 5/0053

(57) ABSTRACT

Certain aspects of the present disclosure provide techniques for compact medium access control (MAC)-control element (CE) design for activating transmission configuration indicator (TCI) states. A method that may be performed by a user equipment (UE) includes receiving signaling configuring the UE with a plurality of transmission configuration indication (TCI) states, receiving a medium access control MAC-CE activating one or more TCI states, wherein the MAC-CE indicates whether one or more TCI codepoints are used to select a single activated downlink (DL) TCI state, a single activated uplink (UL) TCI state, or paired activated DL and UL TCI states, receiving a downlink control information (DCI) with a TCI field; and determining at least one of a receive beam or a transmit beam to use for a transmission scheduled by the DCI, based on the TCI field and the MAC-CE.

### INTRODUCTION

### Field of the Disclosure

Aspects of the present disclosure relate to wireless communications, and more particularly, to techniques for compact medium access control (MAC) control element (CE) design for activating transmission configuration indicator (TCI) states.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These and other multiple access technologies have been adopted in various telecommunication standards to provide a common protocol that enables different wireless devices to communicate on a municipal, national, regional, and even global level. However, as the demand for mobile broadband access continues to increase, there exists a need for further improvements in these and emerging wireless communications technologies.

### SUMMARY

Certain aspects can be implemented in a method for wireless communication by a user equipment (UE). The method generally includes receiving signaling configuring the UE with a plurality of transmission configuration indication (TCI) states; receiving a medium access control (MAC) control element (CE) activating one or more TCI states, wherein the MAC-CE indicates whether one or more TCI codepoints are used to select a single activated downlink (DL) TCI state, a single activated uplink (UL) TCI state, or paired activated DL and UL TCI states; receiving a downlink control information (DCI) with a TCI field; and determining at least one of a receive beam or a transmit beam to use for a transmission scheduled by the DCI, based on the TCI field and the MAC-CE.

Certain aspects can be implemented in a method for wireless communication by a network entity. The method generally includes transmitting signaling configuring a user equipment (UE) with a plurality of transmission configuration indication (TCI) states; transmitting a medium access control (MAC) control element (CE) activating one or more TCI states, wherein the MAC-CE indicates whether one or more TCI codepoints are used to select a single activated downlink (DL) TCI state, a single activated uplink (UL) TCI state, or paired activated DL and UL TCI states; transmitting a downlink control information (DCI) with a TCI field; and determining at least one of a receive beam or a transmit beam to use for a transmission scheduled by the DCI, based on the TCI field and the MAC-CE.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the appended drawings set forth in detail certain illustrative features of the one or more aspects. These features are indicative, however, of but a few of the various ways in which the principles of various aspects may be employed.

### BRIEF DESCRIPTION OF THE FIGURES

The appended figures depict certain features of the various aspects described herein and are not to be considered limiting of the scope of this disclosure.

FIG. 1 is a block diagram conceptually illustrating an example wireless communication network, in accordance with certain aspects of the present disclosure.

FIG. 2 is a block diagram conceptually illustrating aspects of an example a base station (BS) and user equipment (UE), in accordance with certain aspects of the present disclosure.

FIGS. 3A-3D depict various example aspects of data structures for a wireless communication network, in accordance with certain aspects of the present disclosure.

FIG. 4 illustrates how different synchronization signal blocks (SSBs) may be sent using different beams, in accordance with certain aspects of the present disclosure.

FIG. 5 shows an exemplary transmission resource mapping, according to aspects of the present disclosure.

FIG. 6 illustrates example quasi co-location (QCL) relationships, in accordance with certain aspects of the present disclosure.

FIGS. 7A-7B are diagrams illustrating example multiple transmission reception point (TRP) transmission scenarios, in accordance with certain aspects of the present disclosure.

FIGS. 8A-8B illustrates an example mechanism for activating transmission configuration indicator (TCI) states for TRP operations, in accordance with certain aspects of the present disclosure.

FIG. 9 is an example call flow diagram illustrating example operations for wireless communication between a UE and a network entity, in accordance with certain aspects of the present disclosure.

FIG. 10 illustrates an example medium access control (MAC) control element (CE) format, in accordance with certain aspects of the present disclosure.

FIG. 11 illustrates another example MAC-CE format, in accordance with certain aspects of the present disclosure.

FIG. 12 illustrates still another example MAC-CE format, in accordance with certain aspects of the present disclosure.

FIG. 13 is a flow diagram illustrating example operations for wireless communication by a UE, in accordance with certain aspects of the present disclosure.

FIG. 14 is a flow diagram illustrating example operations for wireless communication by a network entity, in accordance with certain aspects of the present disclosure.

FIG. 15 illustrates an example wireless communications device configured to perform operations for the methods disclosed herein, in accordance with certain aspects of the present disclosure.

FIG. 16 illustrates an example wireless communications device configured to perform operations for the methods disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide techniques for compactly indicating, via a medium access control (MAC)-control element (CE), whether one or more transmission configuration indicator (TCI) codepoints are used to select a single activated downlink (DL) TCI state, a single activated uplink (UL) TCI state, or paired activated DL and UL TCI states.

In some cases, a UE may be configured with separate DL/UL TCI states. The number of configured TCI states a UE can support is typically a UE capability including the following candidate values per bandwidth part (BWP) per component carrier (CC). For example, depending on UE capability, a UE may support 64 or 128 DL TCI states and 32 or 64 UL TCI states. In some cases, a joint TCI state may refer to a case where DL common and UL common spatial filters are assumed to be DL-UL reciprocal. A single codepoint may be used to indicate both UL and DL TCI states.

In some cases, when a user equipment (UE) supports one or two TCI states in a codepoint of a TCI field of a downlink control information (DCI), a MAC-CE may be used to activate one or a pair of TCI states for one or more codepoints (e.g., typically up to eight codepoints) to the TCI field of a DCI. Accordingly, the activation command, for each codepoint, may need to indicate whether the codepoint is activated with a single activated DL TCI state, a single activated UL TCI state, or paired activated DL and UL TCI states, as well as, TCI identifier(s) (ID(s)) for the single activated DL TCI state, the single activated UL TCI state, or the paired activated DL and UL TCI states. This presents a challenge, in terms of signaling efficiency. For example, without careful design of the MAC-CE, the MAC-CE conveying such information may use more bits than necessary to convey the essential information for TCI state activation, which may cause overhead.

Aspects of the present disclosure provide various designs for efficiently indicating whether and when different TCIs are paired for a single codepoint to reduce a number of fields used in the MAC-CE (e.g., which may reduce the size of the MAC-CE). The MAC-CE designs presented herein may be considered relatively compact, providing flexibility in activating and specifying TCI states, while efficiently using signaling resources.

### Introduction to Wireless Communication Networks

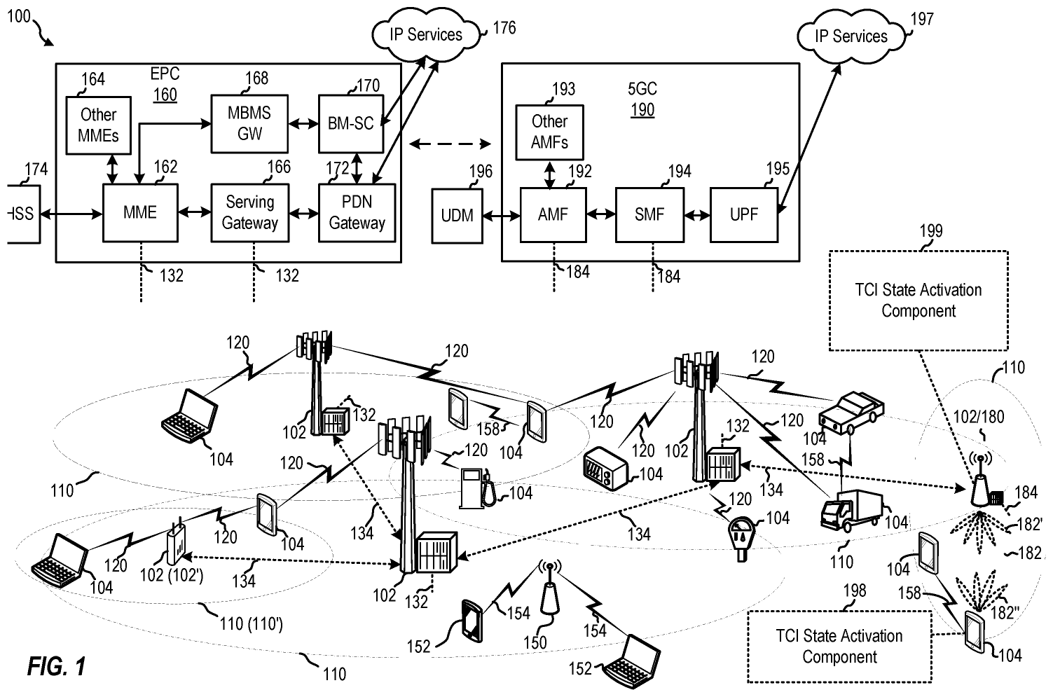

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

BSs 102 may provide an access point to the EPC 160 and/or 5GC 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

A BS, such as BS 102, may include components that are located at a single physical location or components located at various physical locations. In examples in which the base station includes components that are located at various physical locations, the various components may each perform various functions such that, collectively, the various components achieve functionality that is similar to a base station that is located at a single physical location. As such, a base station may equivalently refer to a standalone base station or a base station including components that are located at various physical locations or virtualized locations. In some implementations, a base station including components that are located at various physical locations may be referred to as or may be associated with a disaggregated radio access network (RAN) architecture, such as an Open RAN (O-RAN) or Virtualized RAN (VRAN) architecture. In some implementations, such components of a base station may include or refer to one or more of a central unit (CU), a distributed unit (DU), or a radio unit (RU).

BSs 102 wirelessly communicate with UEs 104 via communications links 120. Each of BSs 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming.

In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

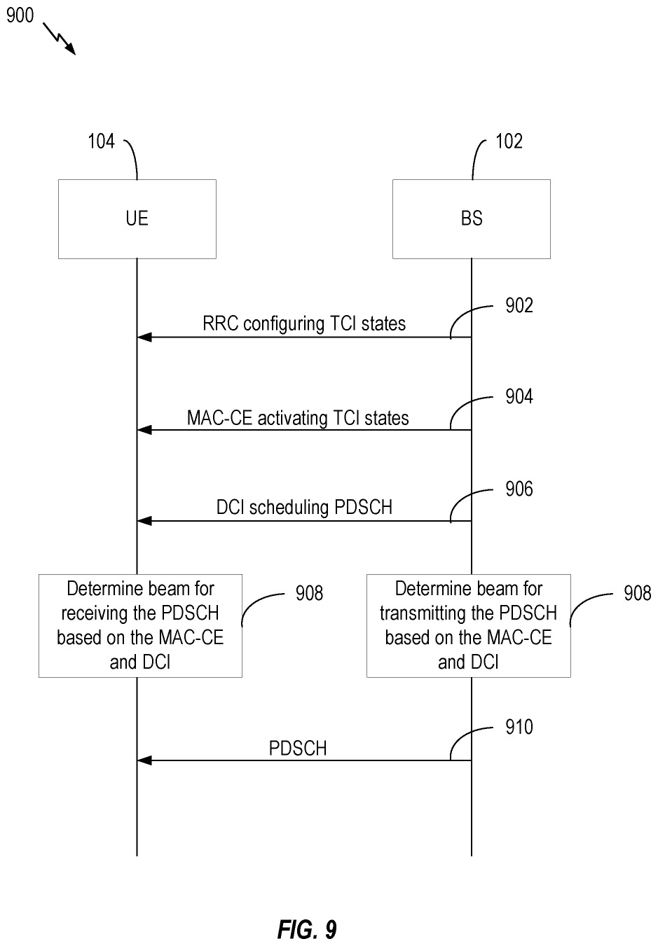

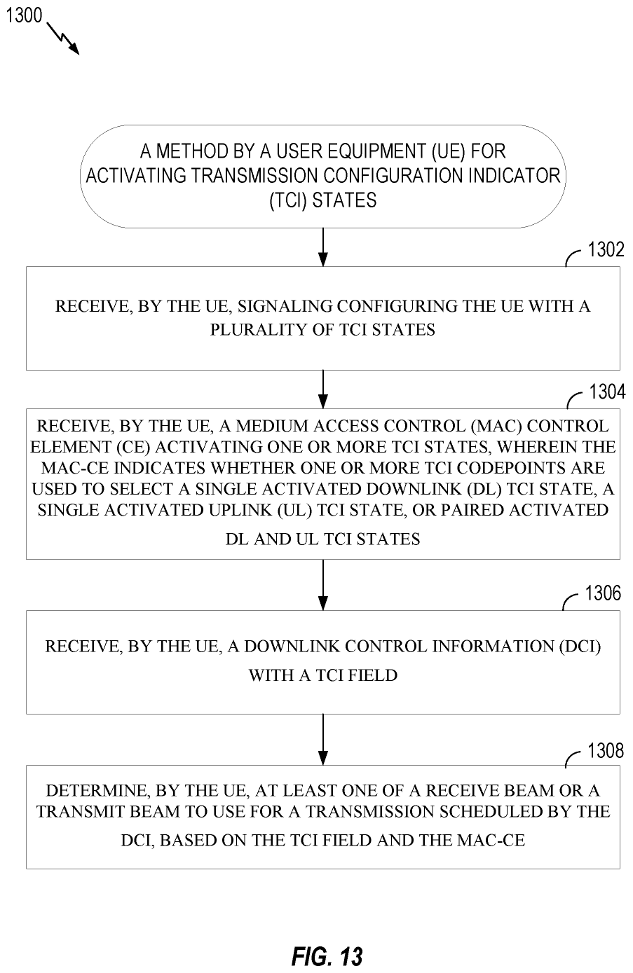

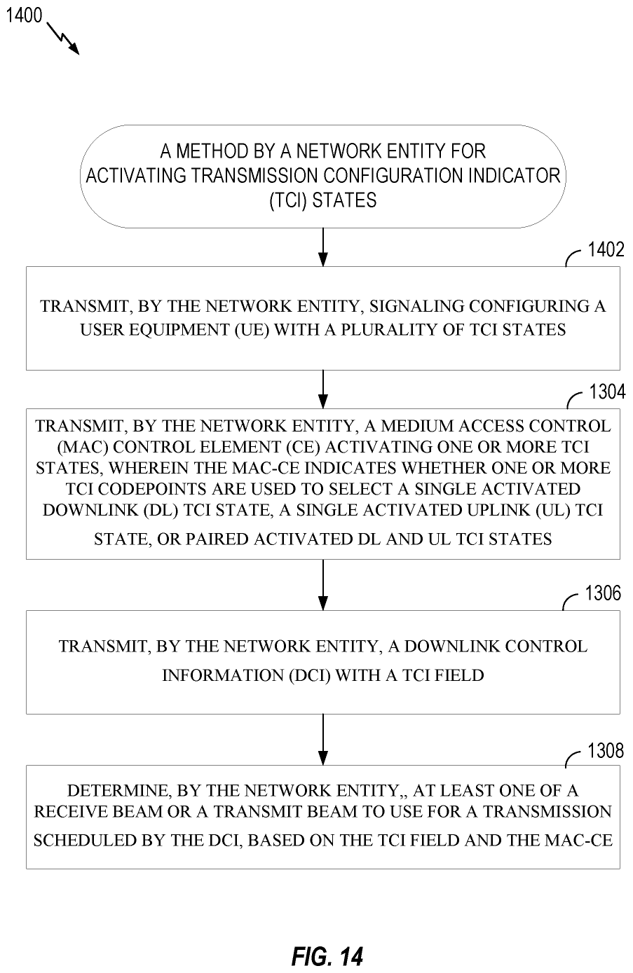

In some cases, BS 102 in wireless communication network 100 may include a TCI state activation component 199, which may be configured to perform the operations depicted and described with respect to FIGS. 9 and 14, as well as other operations described herein for receiving UE capability information for one or more TCI beam indication types. Additionally, a UE 104 in wireless communication network 100 may include a TCI state activation component 198, which may be configured to perform the operations depicted and described with respect to FIGS. 9 and 13, as well as other operations described herein for activating TCI states.

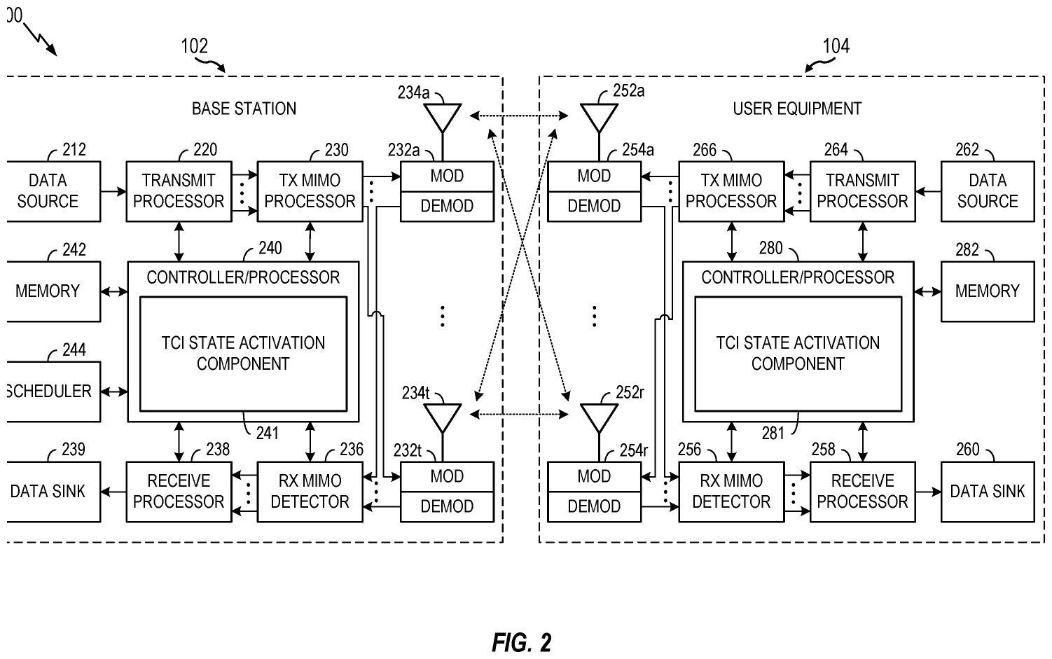

FIG. 2 depicts aspects of an example BS 102 and a UE 104. Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104.

BS 102 includes controller/processor 240, which may be configured to implement various functions related to wireless communications. In the depicted example, controller/processor 240 includes Guard Interval Component 241, which may be representative of Guard Interval Component 199 of FIG. 1. Notably, while depicted as an aspect of controller/processor 240, Guard Interval Component 241 may be implemented additionally or alternatively in various other aspects of BS 102 in other implementations.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

UE 104 includes controller/processor 280, which may be configured to implement various functions related to wireless communications. In the depicted example, controller/processor 280 includes Guard Interval Component 281, which may be representative of Guard Interval Component 198 of FIG. 1. Notably, while depicted as an aspect of controller/processor 280, Guard Interval Component 281 may be implemented additionally or alternatively in various other aspects of UE 104 in other implementations.

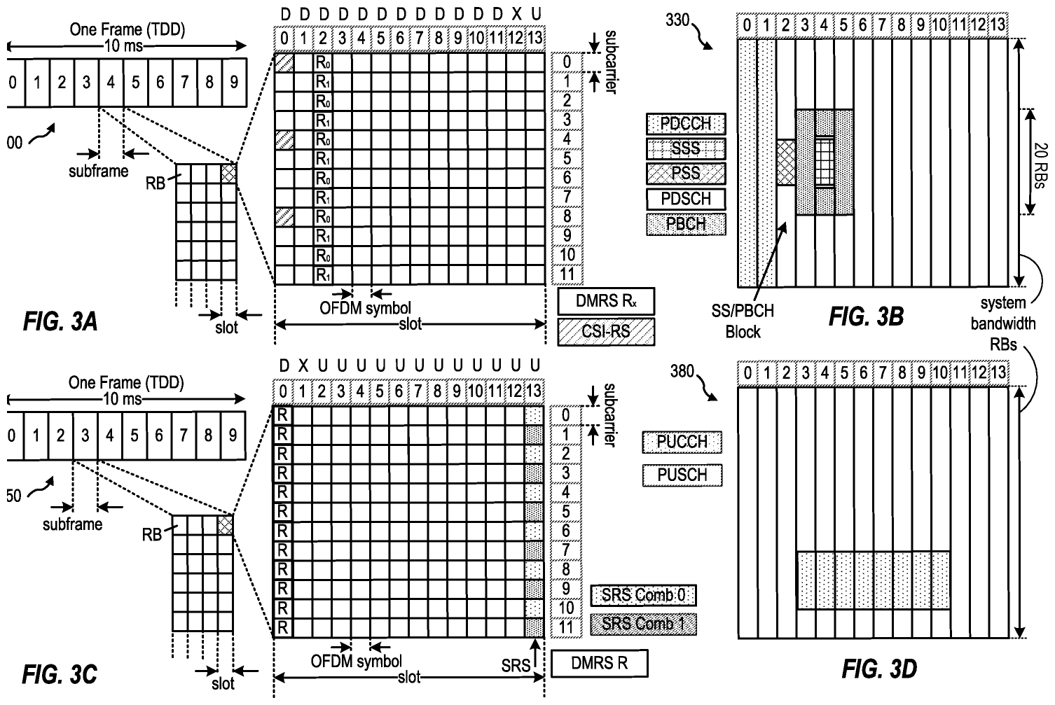

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A, 3B, 3C, and 3D are provided later in this disclosure.

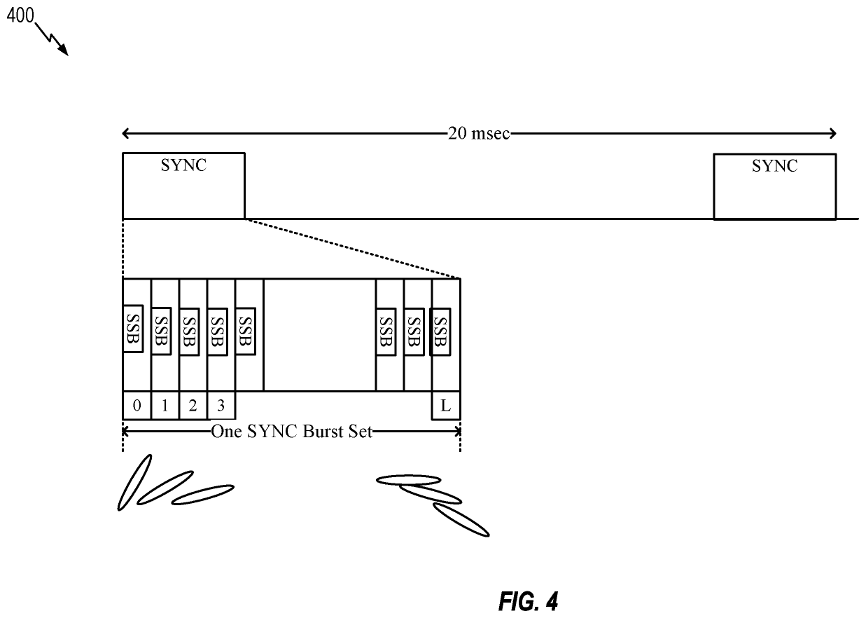

In NR, a synchronization signal block (SSB) is transmitted. The SSB includes a primary synchronization signal (PSS), a secondary synchronization signal (SSS), and a two symbol physical broadcast channel (PBCH). The SSB can be transmitted in a fixed slot location, such as the symbols 0-3 as shown in FIG. 4. The PSS and SSS may be used by UEs for cell search and acquisition. The PSS may provide half-frame timing, and the SSS may provide the cyclic prefix (CP) length and frame timing. The PSS and SSS may provide the cell identity. The PBCH carries some basic system information, such as downlink system bandwidth, timing information within radio frame, synchronization signal (SS) burst set periodicity, system frame number, etc. Further system information such as, remaining minimum system information (RMSI), system information blocks (SIBs), other system information (OSI) can be transmitted on a physical downlink shared channel (PDSCH) in certain subframes.

FIG. 4 illustrates how different synchronization signal blocks (SSBs) may be sent using different beams, in accordance with certain aspects of the present disclosure. As illustrated, the SSBs may be organized into SS burst sets to support beam sweeping. As shown, each SSB within a burst set may be transmitted using a different beam, which may help a UE quickly acquire both transmit (TX) and receive (RX) beams (particular for millimeter wave (mmW) applications). A physical cell identity (PCI) may still decoded from the PSS and SSS of the SSB.

Certain deployment scenarios may include one or both NR deployment options. Some may be configured for non-standalone (NSA) and/or standalone (SA) option. A standalone cell may need to broadcast both SSB and RMSI, for example, with SIB1 and SIB2. An NSA cell may only need to broadcast SSB, without broadcasting RMSI. In a single carrier in NR, multiple SSBs may be sent in different frequencies, and may include the different types of SSBs.

### Control Resource Sets (CORESETs)

A control resource set (CORESET) for an orthogonal frequency division multiple access (OFDMA) system (e.g., a communications system transmitting physical downlink control channels (PDCCHs) using OFDMA waveforms) may comprise one or more control resource (e.g., time and frequency resources) sets, configured for conveying PDCCH, within the system bandwidth (e.g., a specific area on the New Radio (NR) Downlink Resource Grid) and a set of parameters used to carry PDCCH/downlink control information (DCI). For example, a CORESET may be similar in area to an LTE PDCCH area (e.g., the first 1,2,3,4 orthogonal frequency division multiplexed (OFDM) symbols in a subframe).

Within each CORESET, one or more search spaces (e.g., common search space (CSS), UE-specific search space (USS), etc.) may be defined for a given user equipment (UE). Search spaces are generally areas or portions where a communication device (e.g., a UE) may look for control information.

According to aspects of the present disclosure, a CORESET is a set of time and frequency domain resources, defined in units of resource element groups (REGs). Each REG may comprise a fixed number (e.g., twelve) tones/subcarriers in one symbol period (e.g., a symbol period of a slot), where one tone in one symbol period is referred to as a resource element (RE). A fixed number of REGs, such as six, may be included in a control channel element (CCE). Sets of CCEs may be used to transmit NR-PDCCHs, with different numbers of CCEs in the sets used to transmit NR-PDCCHs using differing aggregation levels. Multiple sets of CCEs may be defined as search spaces for UEs, and thus a NodeB or other base station (BS) may transmit an NR-PDCCH to a UE by transmitting the NR-PDCCH in a set of CCEs that is defined as a decoding candidate within a search space for the UE. The UE may receive the NR-PDCCH by searching in search spaces for the UE and decoding the NR-PDCCH transmitted by the NodeB.

As noted above, different aggregation levels may be used to transmit sets of CCEs. Aggregation levels may be generally be defined as the number of CCEs that consist of a PDCCH candidate and may include aggregation levels 1, 2, 4, 8, and 18, which may be configured by a radio resource control (RRC) configuration of a search space set (SS-set). A CORESET may be linked with the SS-set within the RRC configuration. For each aggregation level, the number of PDCCH candidates may be RRC configurable.

Operating characteristics of a NodeB or other BS in an NR communications system may be dependent on a frequency range (FR) in which the system operates. A frequency range may comprise one or more operating bands (e.g., “n1” band, “n2” band, “n7” band, and “n41” band), and a communications system (e.g., one or more NodeBs and UEs) may operate in one or more operating bands. Frequency ranges and operating bands are described in more detail in “Base Station (BS) radio transmission and reception” TS38.104 (Release 15), which is available from the 3GPP website.

As described above, a CORESET is a set of time and frequency domain resources. The CORESET can be configured for conveying PDCCH within system bandwidth. A UE may determine a CORESET and monitor the CORESET for control channels. During initial access, a UE may identify an initial CORESET (CORESET #0) configuration from a field (e.g., pdcchConfigSIB1) in a maser information block (MIB). This initial CORESET may then be used to configure the UE (e.g., with other CORESETs and/or bandwidth parts (BWPs) via dedicated (UE-specific) signaling. When the UE detects a control channel in the CORESET, the UE attempts to decode the control channel and communicates with the transmitting BS (e.g., the transmitting cell) according to the control data provided in the control channel (e.g., transmitted via the CORESET).

In some cases, CORESET #0 may include different numbers of resource blocks (RBs). For example, in some cases, CORESET #0 may include one of 24, 48, or 96 RBs. For other CORESETSs, a 45-bit bitmap may be used to configure available RB-groups, where each bit in the bitmap is with respect to 6-RBs within a BWP and a most significant bit corresponds to the first RB-group in the BWP.

According to aspects of the present disclosure, when a UE is connected to a cell (or BS), the UE may receive a master information block (MIB). The MIB can be in a synchronization signal and physical broadcast channel (SS/PBCH) block (e.g., in the PBCH of the SS/PBCH block) on a synchronization raster (sync raster). In some scenarios, the sync raster may correspond to a synchronization signal block (SSB). From the frequency of the sync raster, the UE may determine an operating band of the cell. Based on a cell's operation band, the UE may determine a minimum channel bandwidth and a subcarrier spacing (SCS) of the channel. The UE may then determine an index from the MIB (e.g., four bits in the MIB, conveying an index in a range 0-15).

Given this index, the UE may look up or locate a CORESET configuration (this initial CORESET configured via the MIB is generally referred to as CORESET #0). This may be accomplished from one or more tables of CORESET configurations. These configurations (including single table scenarios) may include various subsets of indices indicating valid CORESET configurations for various combinations of minimum channel bandwidth and subcarrier spacing (SCS). In some arrangements, each combination of minimum channel bandwidth and SCS may be mapped to a subset of indices in the table.

Alternatively or additionally, the UE may select a search space CORESET configuration table from several tables of CORESET configurations. These configurations can be based on a minimum channel bandwidth and SCS. The UE may then look up a CORESET configuration (e.g., a Type0-PDCCH search space CORESET configuration) from the selected table, based on the index. After determining the CORESET configuration (e.g., from the single table or the selected table), the UE may then determine the CORESET to be monitored (as mentioned above) based on the location (in time and frequency) of the SS/PBCH block and the CORESET configuration.

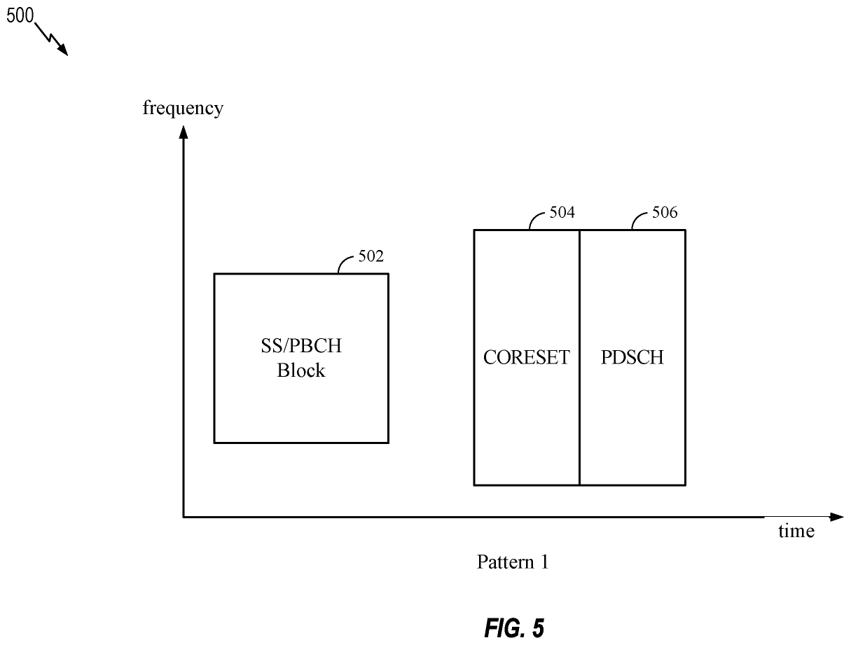

FIG. 5 shows an exemplary transmission resource mapping 500, in accordance with certain aspects of the present disclosure. In the exemplary mapping, a BS (e.g., such as BS 110a shown in FIG. 1 and FIG. 2) transmits an SS/PBCH block 502. SS/PBCH block 502 includes an MIB conveying an index to a table that relates the time and frequency resources of CORESET 504 to the time and frequency resources of SS/PBCH block 502.

The BS may also transmit control signaling. In some scenarios, the BS may also transmit a PDCCH to a UE (e.g., such as UE 120a shown in FIG. 1 and FIG. 2) in the (time/frequency resources of the) CORESET. The PDCCH may schedule a PDSCH 506. The BS then transmits the PDSCH to the UE. The UE may receive the MIB in SS/PBCH block 502, determine the index, look up a CORESET configuration based on the index, and determine the CORESET from the CORESET configuration and SS/PBCH block 502. The UE may then monitor the CORESET, decode the PDCCH in the CORESET, and receive PDSCH 506 that was allocated by the PDCCH.

Different CORESET configurations may have different parameters that define a corresponding CORESET. For example, each configuration may indicate a number of resource blocks (RBs) (e.g., 24, 48, or 96), a number of symbols (e.g., 1-3), as well as an offset (e.g., 0-38 RBs) that indicates a location in frequency.

Further, REG bundles may be used to convey CORESETs. REGs in an REG bundle may be contiguous in a frequency and/or a time domain. In certain cases, the time domain may be prioritized before the frequency domain. REG bundle sizes may include: 2, 3, or 6 for interleaved mapping and 6 for non-interleaved mapping.

As noted above, sets of CCEs may be used to transmit NR-PDCCHs, with different numbers of CCEs in the sets used to transmit the NR-PDCCHs using differing aggregation levels.

### Quasi Co-Location (QCL) Port and Transmission Configuration Indication (TCI) States

In many cases, it may be important for a user equipment (UE) to know which assumptions it may make on a channel corresponding to different transmissions. For example, the UE may need to know which reference signals (RSs) it may use to estimate the channel in order to decode a transmitted signal (e.g., physical downlink control channel (PDCCH) or physical downlink shared channel (PDSCH)). It may also be important for the UE to be able to report relevant channel state information (CSI) to the BS (gNB) for scheduling, link adaptation, and/or beam management purposes. In NR, the concept of quasi co-location (QCL) and transmission configuration indicator (TCI) states may be used to convey information about these assumptions.

QCL assumptions may be defined in terms of channel properties. Per 3rd Generation Partnership Project (3GPP) Technical Specification (TS) 38.214, “two antenna ports are said to be quasi-co-located if properties of the channel over which a symbol on one antenna port is conveyed can be inferred from the channel over which a symbol on the other antenna port is conveyed.” Different RSs may be considered quasi co-located (“QCL'd”) if a receiver (e.g., a UE) can apply channel properties determined by detecting a first RS to help detect a second RS. TCI states may include configurations such as QCL-relationships, for example, between the downlink (DL) RSs in one CSI-RS set and the PDSCH demodulation reference signal (DMRS) ports.

In some cases, a UE may be configured with up to M TCI-States. Configuration of the M TCI-States can come about via higher layer signalling, while a UE may be signalled to decode PDSCH according to a detected PDCCH with downlink control information (DCI) indicating one of the TCI states. Each configured TCI state may include one RS set TCI-RS-SetConfig that indicates different QCL assumptions between certain source and target signals.

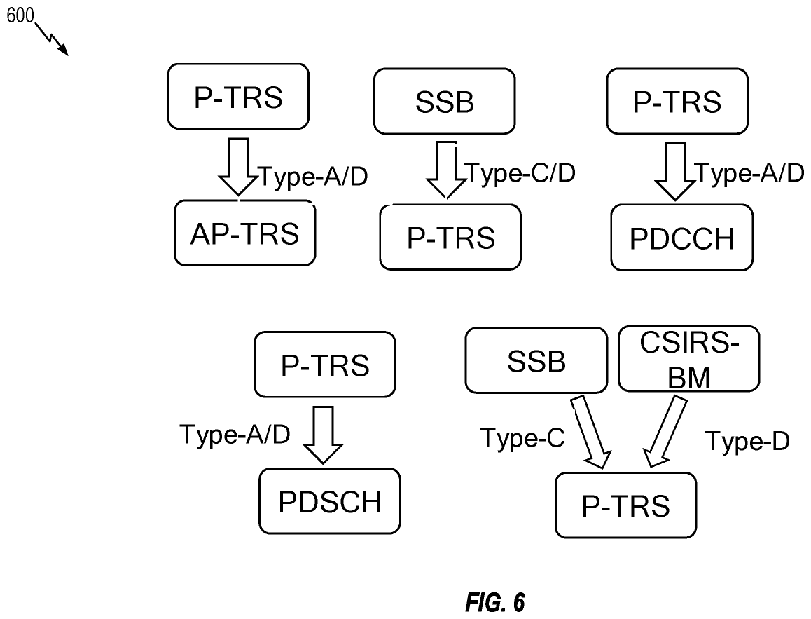

FIG. 6 illustrates example QCL relationships, in accordance with certain aspects of the present disclosure. More specifically, FIG. 6 illustrates examples of the association of DL RSs with corresponding QCL types that may be indicated by a TCI-RS-SetConfig.

In the examples of FIG. 6, a source RS may be indicated in the top block and may be associated with a target signal indicated in the bottom block. In this context, a target signal may refer to a signal for which channel properties may be inferred by measuring those channel properties for an associated source signal. As described herein, a UE may use the source RS to determine various channel parameters, depending on the associated QCL type, and use those various channel properties (determined based on the source RS) to process the target signal. A target RS may not necessarily need to be PDSCH's DMRS, rather it may be any other RS, such as, a physical uplink shared channel (PUSCH) DMRS, CSI-RS, tracking reference signal (TRS), and sounding reference signal (SRS).

As illustrated, each TCI-RS-SetConfig may contain parameters. These parameters may, for example, configure QCL relationship(s) between RSs in the RS set and the DMRS port group of the PDSCH. The RS set may contain a reference to either one or two DL RSs and an associated QCL-Type for each one configured by the higher layer parameter QCL-Type.

As illustrated in FIG. 6, for the case of two DL RSs, the QCL types may take on a variety of arrangements. For example, QCL types may not be the same, regardless of whether the references are to the same DL RSs or different DL RSs. In the illustrated example, a SSB may be associated with Type C QCL for phase tracking reference signal (P-TRS), while CSI-RS for beam management (CSIRS-BM) may be associated with Type D QCL.

QCL information and/or types may, in some scenarios, depend on or be a function of other information. For example, the QCL types indicated to the UE may be based on higher layer parameter QCL-Type and may take one or a combination of the following types:
QCL-TypeA: {Doppler shift, Doppler spread, average delay, delay spread},
QCL-TypeB: {Doppler shift, Doppler spread},
QCL-TypeC: {average delay, Doppler shift}, and
QCL-TypeD: {Spatial RX parameter},
   Spatial QCL assumptions (QCL-TypeD) may be used to help a UE select an analog RX beam (e.g., during beam management procedures). For example, an SSB resource indicator may indicate a same beam for a previous RS should be used for a subsequent transmission.

An initial CORESET (e.g., CORESET ID 0 or simply CORESET #0) in NR may be identified during initial access by a UE (e.g., via a field in the MIB). A ControlResourceSet information element (CORESET IE), sent via radio resource control (RRC) signaling, may convey information regarding a CORESET configured for a UE. The CORESET IE generally includes a CORESET ID, an indication of frequency domain resources (e.g., number of RBs) assigned to the CORESET, contiguous time duration of the CORESET in a number of symbols, and TCI states.

As noted above, a subset of the TCI states may provide QCL relationships between DL RS(s) in one RS set (e.g., TCI-Set) and PDCCH DMRS ports. A particular TCI state for a given UE (e.g., for unicast PDCCH) may be conveyed to the UE via a Medium Access Control (MAC) Control Element (MAC-CE). The particular TCI state may be selected from the set of TCI states conveyed by the CORESET IE, with the initial CORESET (CORESET #0) generally configured via MIB.

Search space information may also be provided via RRC signaling. For example, the Search Space IE is another RRC IE that defines how and where to search for PDCCH candidates for a given CORESET. Each search space may be associated with one CORESET. The Search Space IE may identify a search space configured for a CORESET by a search space ID. In an aspect, the search space ID associated with CORESET #0 may be Search Space ID #0. The search space may be generally configured via PBCH (MIB).

Under a unified TCI framework, different types of TCI states may be indicated. For example, a type 1 TCI may be a joint DL/UL TCI state to indicate a common beam for at least one DL channel or RS and at least one UL channel or RS. A type 2 TCI may be a DL (e.g., separate from UL) TCI state to indicate a common beam for more than one DL channel or RS. A type 3 TCI may be a UL TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like. A TCI state may be defined to represent at least one source RS to provide a reference (e.g., UE assumption) for determining QCL or spatial filters. For example, a TCI state may define a QCL assumption between a source RS and a target RS.

### Multiple Transmission Reception Point (multi-TRP) Scenarios

New Radio (NR) networks are expected to utilize multiple transmission and reception points (TRPs) to improve reliability and capacity performance through flexible deployment scenarios. For example, allowing user equipments (UEs) to access wireless networks via multiple TRPs (multi-TRPs) may help support increased mobile data traffic and enhance the coverage. Multi-TRPs may be used to implement one or more macro-cells, small cells, pico-cells, or femto-cells, and may include remote radio heads, relay nodes, and the like. Various modes of operation are supported for multi-TRP operation.

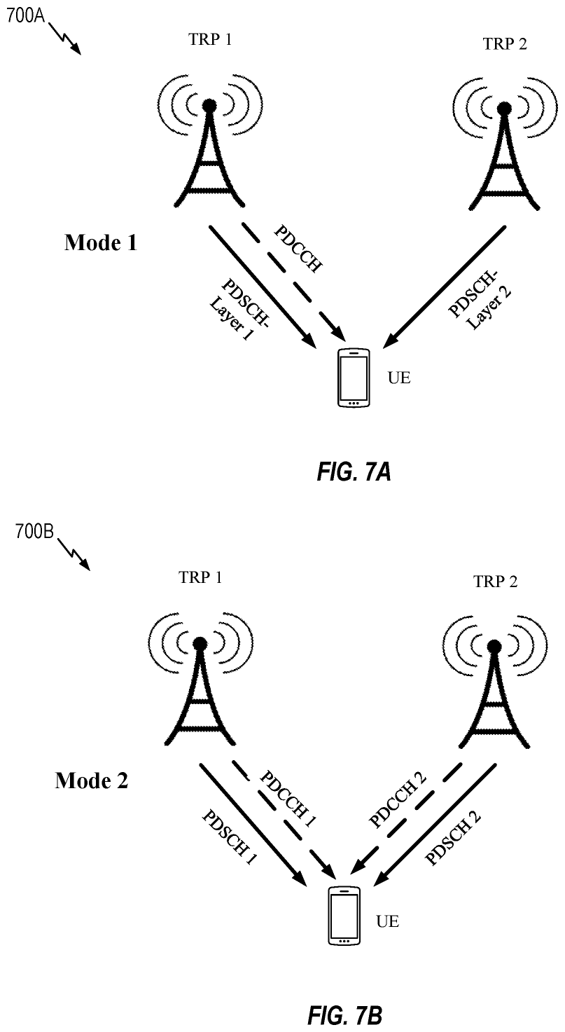

FIG. 7A illustrates an example multi-TRP scenario, in which aspects of the present disclosure may be practiced. As shown in FIG. 7A, an example multi-TRP scenario may include two TRPs (TRP1 and TRP2) serving a UE (UE1). The example illustrated in FIG. 7A illustrates a first mode (Mode 1), where a single PDCCH schedules single PDSCH from multiple TRPs, as illustrated in FIG. 7A. For example, the PDCCH (transmitted from TRP1) may carry a downlink control information (DCI) that schedules a PDSCH from each of TRP1 and TRP2.

In this mode, different TRPs transmit different spatial layers in overlapping resource blocks (RBs)/symbols (spatial division multiplexing (SDM)). The different TRPs transmit in different RBs (frequency division multiplexing (FDM)) and may transmit in different orthogonal frequency division multiplexed (OFDM) symbols (time division multiplexing (TDM)). This mode assumes a backhaul with little or virtually no delay.

FIG. 7B illustrates another example multi-TRP scenario, in which aspects of the present disclosure may be practiced. Similar to FIG. 7A, as shown in FIG. 7B, an example multi-TRP scenario may include two TRPs (TRP1 and TRP2) serving a UE (UE1). The example illustrated in FIG. 7B illustrates a second mode (Mode 2), where multiple PDCCHs schedule respective PDSCH from multiple TRPs. For example, PDCCH1 (transmitted from TRP1) may carry a first DCI that schedules PDSCH1. Similarly, PDCCH2 (transmitted from TRP2) may carry a second DCI that schedules PDSCH2.

Mode 2 can be utilized in both non-ideal and ideal backhauls. To support multiple PDCCH monitoring, up to 5 Control Resource Sets (CORESETs) can be configured with up to 3 CORESETs per TRP. As used herein, the term CORESET generally refers to a set of physical resources (e.g., a specific area on the NR Downlink Resource Grid) and a set of parameters that is used to carry PDCCH/DCI. For example, a CORESET may by similar in area to an LTE PDCCH area (e.g., the first 1,2,3,4 OFDM symbols in a subframe).

In some cases, TRP differentiation at the UE side may be based on CORESET groups. CORESET groups may be defined by higher layer signaling of an index per CORESET which may be used to group the CORESETs. For example, for 2 CORESET groups, two indexes may be used (i.e. index=0 and index=1). Thus, a UE may monitor for transmissions in different CORESET groups and may infer that transmissions sent in different CORESET groups come from different TRPs. There may be other ways in which the notion of different TRPs may be transparent to the UE.

### Medium Access Control (MAC)-Control Element (CE) Transmission Configuration Indication (TCI) State Activation

As mentioned, a user equipment (UE) can be configured with a list of up to M TCI-State configurations within the higher layer parameter PDSCH-Config to decode a physical downlink shared channel (PDSCH) according to a detected physical downlink control channel (PDCCH) with downlink control information (DCI) intended for the UE and the given serving cell, where M depends on the UE capability maxNumberConfiguredTCIstatesPerCC. Each TCI-State contains parameters for configuring a quasi co-location (QCL) relationship between one or two downlink (DL) reference signals (RSs) and the demodulation RS (DM-RS) ports of the PDSCH, the DM-RS port of PDCCH, or the channel state information-RS (CSI-RS) port(s) of a CSI-RS resource.

Different TCI states may exist. For example, in some cases, the TCI states may include several single-channel beam indication types, such as (1) a separate DL single channel/reference signal (RS) TCI state to indicate a beam for a single DL channel/RS, (2) a separate uplink (UL) single channel/RS TCI state to indicate a beam for a single UL channel/RS, and (3) UL spatial relation information (SRI) to indicate a beam for a single UL channel/RS. Additionally, in some cases, the TCI states may include three additional multi-channel beam indication types, including (4) a joint DL/UL common TCI state to indicate a common beam for at least one DL channel/RS and at least one UL channel/RS, (5) a separate DL common TCI state to indicate a common beam for at least two DL channels/RSs, and (6) a separate UL common TCI state to indicate a common beam for at least two UL channels/RSs.

In certain aspects, a subset of the configured TCI states may be activated via a medium access control element (MAC-CE). The MAC-CE may indicate, for each of a set of codepoints, a corresponding TCI state that codepoint maps to. A TCI state may be considered activated if it is mapped to a codepoint via a MAC CE.

In certain aspects, a downlink control information (DCI) may indicate at least one codepoint for a transmission scheduled by the DCI, via a 3-bit indicator in a TCI field of the DCI. The UE may determine at least one of a receive beam or a transmit beam, to use for a transmission scheduled by the DCI, based on the TCI field in the DCI and the MAC-CE. In particular, the UE may receive an activation command, via a MAC-CE, used to map up to eight TCI states to codepoints of the DCI field, “TCI”, in one component carrier (CC)/DL bandwidth part (BWP) or in a set of CCs/DL BWPs, respectively. The UE may use a codepoint indicated in the TCI field of the DCI and this activation command to determine one or more beams to use for a scheduled transmission.

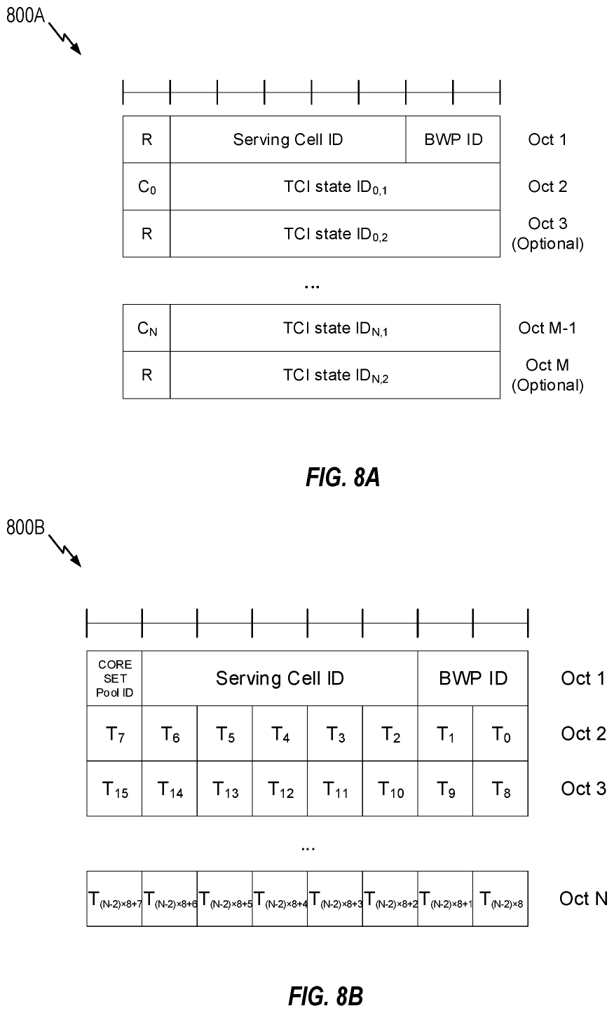

FIG. 8A illustrates one example of a UE-specific MAC-CE 800A for the activation/deactivation of multiple TCI States for a physical downlink shared channel (PDSCH) transmission, in accordance with certain aspects of the present disclosure. MAC-CE 800A may be used, for example, for a single PDSCH (e.g., sDCI) mTRP scenario (e.g., as shown in FIG. 7A). As illustrated, there may be a first TCI state ID_{i,1} for each codepoint up to N codepoints (e.g., where i and N are integers greater than zero). In addition, for each codepoint i, a field Cᵢ may indicate whether a corresponding octet containing a second TCI state ID (e.g., TCI state ID_{i,2}) is present. TCI state ID_{i,j} indicates the TCI state identified by TCI-StateId, where i is the index of the codepoint of the DCI field and j denotes the j^{th} TCI state indicated for the i^{th} codepoint in the DCI in the MAC CE (j=1 or 2).

FIG. 8B illustrates another example of a UE-specific MAC-CE 800B for the activation/deactivation of multiple TCI States for a PDSCH transmission, in accordance with certain aspects of the present disclosure. MAC-CE 800B may be used, for example, for a multiple PDSCH (e.g., mDCI) mTRP scenario (e.g., as shown in FIG. 7B). As illustrated, in some cases, a bitmap may be used to activate/deactivate a subset of TCI states. N octets may be used to convey such bits in the bitmap. In particular, if a bit in a specific location is set to be “1”, then a TCI state mapped to the position of the bit is activated. On the other hand, if the bit is set to “0”, then the TCI state mapped to the position of the bit is deactivated. For example, if T4=1, then index 4 of tci-StatesToAddModList configured in PDSCH-Config is activated.

The “Serving Cell ID” field indicated in MAC-CE 800A and MAC-CE 800B indicates the identity of the Serving Cell for which the MAC-CE applies. The length of the field may be five bits. If the indicated Serving Cell is configured as part of a list of serving cells, the MAC-CE may apply to all the serving cells configured for the set.

The “BWP ID” field indicates a DL BWP for which the MAC-CE applies as the codepoint of the DCI BWP indicator field. The length of the BWP ID field is two bits. This field may be ignored where the MAC-CE applies to a set of serving cells.

The “CORESET Pool ID” filed field indicates that mapping between the activated TCI states and the codepoint of the DCI TCI set by field Ti is specific to the ControlResourceSetID configured with the CORESET Pool ID. For example, CORESET Pool ID field set to “1” may indicate that this MAC-CE shall be applied for the DL transmission scheduled by the CORESET with the CORESET pool ID equal to 1.

### Example Compact Medium Access Control (MAC)-Control Element (CE) Design for Pairing a Downlink (DL) Transmission Configuration Indicator (TCI) State and an Uplink (UL) TCI State in Unified TCI Activation

In some cases, when a user equipment (UE) supports up to two transmission configuration indicator (TCI) states in a codepoint of the TCI field of a downlink control information (DCI), the UE may receive an activation command used to map up to eight combinations of one or two TCI states to the codepoints of the TCI field in the DCI. For example, a first combination may map a downlink (DL) TCI state to one TCI field codepoint and a second combination may map an uplink (UL) TCI state to one TCI field codepoint, while a third combination may map a pair of a DL TCI state and a UL TCI state to one TCI field codepoint.

Accordingly, the activation command, for each codepoint, may need to indicate whether the codepoint is activated with a single activated DL TCI state, a single activated UL TCI state, or paired activated DL and UL TCI states, as well as, TCI identifier(s) (ID(s)) for the single activated DL TCI state, the single activated UL TCI state, or the paired activated DL and UL TCI states. There are various mechanisms that may be used for this indication, with different impacts on signaling resources.

For example, explicitly indicating whether the codepoint is activated with a single activated DL TCI state, a single activated UL TCI state, or paired activated DL and UL TCI states may cost up to two bits in a field in the MAC-CE containing the activation command. Further, in some cases, indicating the TCI ID for the activated DL TCI state may cost up to seven bits when the pool of DL TCI states has a size of 128, indicating the TCI ID for the activated UL TCI state may cost up to six bits when the pool of UL TCI states has a size of 64, and thus, indicating the TCI IDs for the paired activated DL and UL TCI states may cost up to thirteen bits.

Accordingly, without careful design of the activation command for the medium access control (MAC)-control element (CE), information needing to be indicated for a codepoint may need more than one field in the MAC-CE. For example, in some cases an eight bit field in the MAC-CE (e.g., an octet) may be insufficient, for example, when it takes nine bits to indicate a codepoint is activated with a single activated DL TCI state and a TCI ID for the activated DL TCI state (e.g., two bits for the indication and seven bits for the DL TCI). Thus, in this case, two octets with padding (reserved) bits may be needed to convey such information (e.g., given eight bits for one octet is < the nine bits needed) which has a negative impact on signaling overhead.

Accordingly, aspects of the present disclosure provide techniques for compactly indicating, via a MAC-CE, whether one or more TCI codepoints are used to select a single activated downlink (DL) TCI state, a single activated uplink (UL) TCI state, or paired activated DL and UL TCI states. Techniques described herein for TCI state activation, via MAC-CE, may be applied where a UE is configured with a single transmission reception point (sTRP) operation or a multiple DCI (mDCI) based multiple TRP (mTRP) operation (e.g., as illustrated in FIG. 7B).

FIG. 9 is an example call flow diagram 900 illustrating operations performed by a UE (e.g., such as UE 104 illustrated in FIGS. 1 and 2) and a network entity (e.g., such as BS 102 illustrated in FIGS. 1 and 2) for activating a pair of TCI IDs (e.g., a pair of one DL TCI and one UL TCI) for a single codepoint or one TCI ID (e.g., a TCI ID for a DL TCI or a TCI ID for UL TCI) for a single codepoint.

As illustrated in FIG. 9, at 902, UE 104 may be configured, by BS 102, with up to M DL TCI states and/or up to N UL TCI states via high layer signaling, such as radio resource control (RRC) signaling. For example, the RRC signaling may configure up to 128 DL TCI states. The RRC signaling may configure up to 32 or 64 UL TCI states. Additionally, the number of TCI states that the UE may support may be the number of TCI states configured by the RRC signaling. Each configured TCI state may include one reference signal (RS) set TCI-RS-SetConfig that indicates different quasi co-location (QCL) assumptions between certain source and target signals.

In certain aspects, there may be up to eight TCI codepoints for active TCI states in MAC-CE that are mapped in one-to-one order to the up to eight TCI codepoints of the TCI field of a DCI. As illustrated, at 904, BS 102 sends a MAC-CE command to activate TCI states or down-select (e.g., to effectively “down-select” 8 out of 128 relations, for instance) from the TCI states previously configured at 902 for the TCI codepoints of a DCI.

As will be described in more detail below, the MAC-CE may have a compact MAC-CE design for indicating whether one or more codepoints are activated with a single activated DL TCI state, a single activated UL TCI state, or paired activated DL and UL TCI states, as well as, TCI IDs for the single activated DL TCI state, the single activated UL TCI state, or the paired activated DL and UL TCI states. In certain aspects, the compact MAC-CE design may help to ensure that multiple TCI fields (e.g., octets) in the MAC-CE are not used for a single codepoint where less fields may have been sufficient to convey the necessary information for TCI state activation.

At 906, BS 102 transmits, to UE 104, a DCI scheduling a PDSCH. The DCI may include a TCI field (e.g., 3 bits) used to select one out of the eight codepoints included in the MAC-CE, previously sent at 904. At 908, UE 104 determines a beam for receiving the scheduled PDSCH using the MAC-CE received at 904 and the DCI received at 906. Similarly, at 908, BS 102 determines a beam for transmitting the scheduled PDSCH using the MAC-CE transmitted at 904 and the DCI transmitted at 906.

Thereafter, as shown at 910, BS 102 may transmit the PDSCH using the beam determined at 908, and UE 104 may receive the PDSCH using the beam determined at 908. Although the PDSCH is used as an example for applying the TCI, the TCIs activated by the MAC-CE may be applied to other channels based on the TCI type.

Various compact MAC-CE designs (e.g., for MAC-CE transmitted at 904 in FIG. 9) may be considered for activating one or a pair of TCI states per codepoint. In particular, in a first design, the MAC-CE may include, a dedicated bit for each of the one or more TCI codepoints in a single field (e.g., such as, one octet) in the MAC-CE. Each dedicated bit may indicate whether a corresponding TCI codepoint is used to select a single activated DL TCI state, a single activated UL TCI state, or paired activated DL and UL TCI states. For example, when the dedicated bit for the corresponding TCI codepoint is set to a first value (e.g., bit=1), the MAC-CE indicates that TCI codepoint is used to select the paired (jointly) activated DL and UL TCI states. Alternatively, when the dedicated bit for the corresponding TCI codepoint is set to a second value (e.g., bit=0), the MAC-CE indicates that TCI codepoint is used to select a single activated DL TCI state or a single activated UL TCI state.

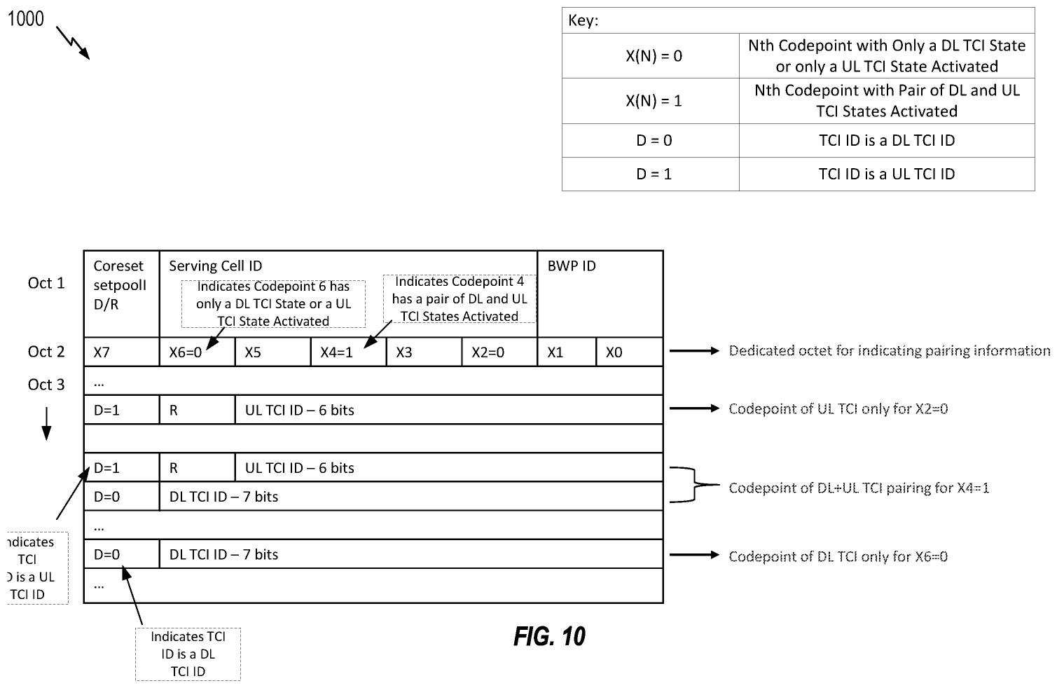

FIG. 10 illustrates an example MAC-CE 1000 having the first MAC-CE design described above, in accordance with certain aspects of the present disclosure. As shown in FIG. 10, example MAC-CE 1000 may have a plurality of fields, and in this case octets, for activating TCI states for up to eight codepoints. The second octet, Octet 2, in example MAC-CE 1000, may include a dedicated bit for n codepoints, where n is an integer greater than zero.

In the example illustrated in FIG. 10, n is equal to the maximum number of TCI codepoints, (e.g., eight for a three-bit TCI field in a DCI); thus, X0 corresponds to the first codepoint, codepoint 0, while X7 corresponds to the eighth codepoint, codepoint 7. Accordingly, a bit set for Xn may indicate the number of TCI states are activated for that nth codepoint. Further, where the bit is set to a first value (e.g., bit=1), the MAC-CE indicates the nth codepoint is used to select paired activated DL and UL TCI states. Alternatively, where the bit is set to a second value (e.g., bit=0), the MAC-CE indicates the nth codepoint is used to select a single activated DL TCI state or a single activated UL TCI state.

For example, in octet 2, a dedicated bit for codepoint 4 (e.g., X4) is set to 1. Accordingly, the dedicated bit set for codepoint 4 indicates that codepoint 4 is used to select paired activated DL and UL TCI states. On the other hand, in octet 2, a dedicated bit for codepoint 2 (e.g., X2) and codepoint 6 (e.g., X6) is set to 0. Accordingly, the dedicated bits set for codepoint 2 and codepoint 6 indicate that codepoint 2 and codepoint 6 are used to select a single activated DL TCI state or a single activated UL TCI state.

Further, in the first design of the MAC-CE, when the dedicated bit for a TCI codepoint is set to the first value (e.g., Xn=1, indicating paired activated DL and UL TCI states for that codepoint), two consecutive fields of the MAC-CE may indicate TCI IDs for the paired activated DL and UL TCI states. In particular, the two consecutive fields may include a first field that indicates a UL TCI ID and a second field that indicates a DL TCI ID. In certain aspects, the DL TCI ID has more bits than the UL TCI ID. For example, the UL TCI ID may be up to six bits in the range from 0-63, while the DL TCI ID may be up to seven bits in the range from 0-127 when using a separate DL/UL TCI pool. In certain aspects, each field of the two consecutive fields includes a bit that indicates whether the TCI ID included in the field is associated with an activated DL TCI state or an activated UL TCI state of the paired activated DL and UL TCI states.

As shown in example MAC-CE 1000 of FIG. 10, because a dedicated bit for codepoint 4 (e.g., X4) is set to 1 (e.g., in octet 2) that indicates that codepoint 4 is used to select paired activated DL and UL TCI states, two consecutive octets of the MAC-CE may indicate TCI IDs for the paired activated DL and UL TCI states for codepoint 4. As shown, a first octet of the two consecutive octets contains the UL TCI ID while the second octet of the two consecutive octets contains the DL TCI ID. In this example, a separate DL/UL TCI pool is used, and the UL TCI ID is six bits, while the DL TCI ID is seven bits. To indicate whether the TCI ID included in the octet is associated with the activated DL TCI state of the paired activated DL and UL TCI states or the activated UL TCI state of the paired activated DL and UL TCI states, an additional bit (e.g., D) is included in each of the two consecutive octets. In particular, D set to a first value (e.g., D=1) indicates that the TCI ID included in the octet is a UL TCI ID and D set to a second value (e.g., D=0) indicates that the TCI ID included in the octet is a DL TCI ID. Assuming there are no more than 64 UL TCI states, each UL TCI state may be indicated by six bits. Thus, if the first bit of the octet (D=1) indicates an UL TCI state, one of the seven bits may be reserved (R) while the remaining six indicate the UL TCI state.

Alternatively, in the first design of the MAC-CE, when the dedicated bit for a TCI codepoint is set to the second value (e.g., Xn=0, indicating a single activated DL TCI state or a single activated UL TCI state), a single field for the corresponding TCI codepoint indicates a TCI ID for the single activated DL TCI state or the single activated UL TCI state. As mentioned, in certain aspects, the DL TCI ID has more bits than the UL TCI ID. For example, the UL TCI ID may be up to six bits in the range from 0-63, while the DL TCI ID may be up to seven bits in the range from 0-127 when using a separate DL/UL TCI pool. In certain aspects, the single field further includes a bit indicating whether the TCI ID included in the single field is associated with the activated DL TCI state or the activated UL TCI state.

As shown in example MAC-CE 1000 of FIG. 10, because a dedicated bit for codepoint 2 (e.g., X2) is set to 0 (e.g., in octet 2) that indicates that codepoint 2 is used to select a single activated DL TCI state or a single activated UL TCI state, a single octet of the MAC-CE may indicate a TCI ID for either the single activated DL TCI state or the single activated UL TCI state for codepoint 2. For example, as shown, one octet may be used to convey the TCI ID for codepoint 2. In this example, the activated TCI state for codepoint 2 is an UL TCI state; thus, the octet contains the UL TCI ID associated with the activated UL TCI state, where the UL TCI is six bits. To indicate that the TCI ID included in the octet is associated with the activated UL TCI state, an additional bit (e.g., D, also referred to as a special bit) is included in the octet. In particular, D is set to a first value (e.g., D=1) indicating that the TCI ID included in the octet is a UL TCI ID.

Similarly, as shown in in example MAC-CE 1000 of FIG. 10, because a dedicated bit for codepoint 6 (e.g., X6) is set to 1 (e.g., in octet 2) that indicates that codepoint 6 is used to select the single activated DL TCI state or the single activated UL TCI state, a single octet of the MAC-CE may indicate a TCI ID for either the single activated DL TCI state or the single activated UL TCI state for codepoint 6. For example, as shown, one octet may be used to convey the TCI ID for codepoint 6. In this example, the activated TCI state for codepoint 6 is DL TCI state (as opposed to a UL TCI state activated for codepoint 2); thus, the octet contains the DL TCI ID associated with the activated DL TCI state, where the DL TCI is seven bits. To indicate that the TCI ID included in the octet is associated with the activated DL TCI state, an additional bit (e.g., D) is included in the octet. In particular, D is set to a second value (e.g., D=0) indicating that the TCI ID included in the octet is a DL TCI ID.

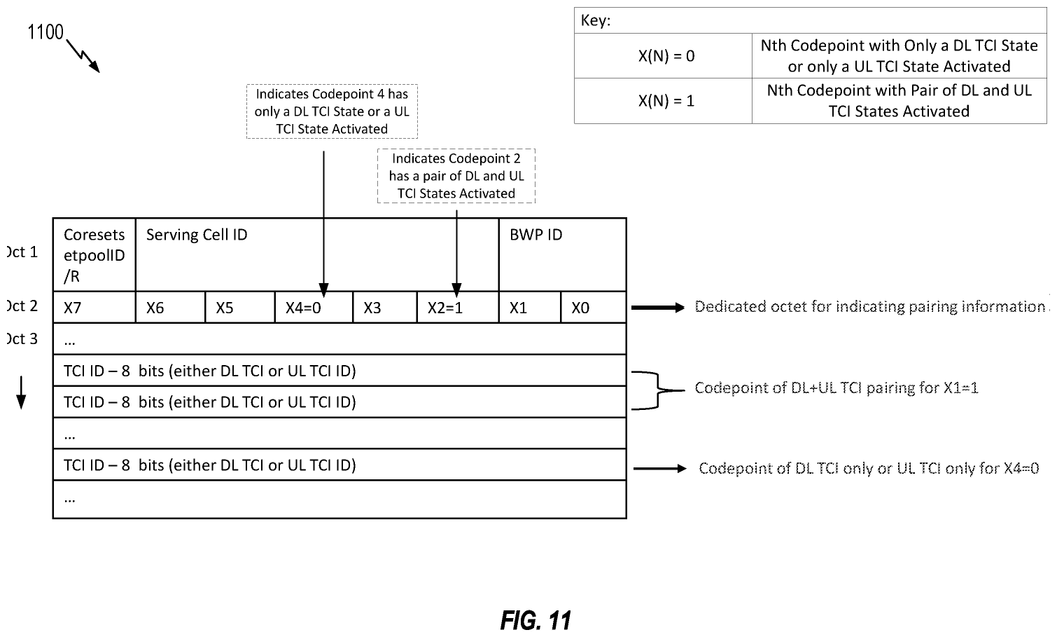

FIG. 11 illustrates another example MAC-CE 1100 having the first MAC-CE design, in accordance with certain aspects of the present disclosure. As shown in FIG. 11, similar to FIG. 10, example MAC-CE 1100 may have a plurality of fields, and in this case octets, for activating TCI states for up to eight codepoints. The second octet, Octet 2, in the MAC-CE, may include a dedicated bit for n codepoints, where n is an integer greater than zero. A bit set for a codepoint (e.g., Xn) may indicate TCI states are activated for that nth codepoint. Further, where the bit is set to a first value (e.g., bit=1), the MAC-CE indicates the nth codepoint is used to select paired activated DL and UL TCI states. Alternatively, where the bit is set to a second value (e.g., bit=0), the MAC-CE indicates the nth codepoint is used to select a single activated DL TCI state or a single activated UL TCI state.

Unlike FIG. 10 however, in certain aspects, a joint DL/UL TCI state pool may be used, and a TCI ID associated with each of the DL TCI state and the UL TCI state may include up to eight bits. Because the pool is a joint DL/UL TCI state pool, a bit indicating whether a TCI ID included in an octet is associated with a DL TCI state or associated with an UL TCI state may not be necessary. In other words, given the TCI ID itself, a UE may be able to determine whether an UL or DL, the TCI ID indicated in an octet for a codepoint is associated with. Accordingly, the additional bit (e.g., D) may not be included in the octet indicating the TCI ID(s) for each codepoint.

As mentioned, various compact MAC-CE designs (e.g., for MAC-CE transmitted at 904 in FIG. 9) may be considered for activating one or a pair of TCI states per codepoint. Beyond the first MAC-CE design illustrated in FIGS. 9 and 10, a second design may also be used for activating TCI states. In particular, in the second design, the MAC-CE may include, a first dedicated bit for each of the one or more TCI codepoints, where the first dedicated bit, for each of the one or more TCI codepoints, is included in a separate field (e.g., such as in separate octets) in the MAC-CE. Each dedicated bit may indicate whether a corresponding TCI codepoint is used to select a single activated DL TCI state, a single activated UL TCI state, or paired activated DL and UL TCI states. For example, when a field includes a dedicated bit for a corresponding TCI codepoint that is set to a first value (e.g., bit=0), the MAC-CE indicates that TCI codepoint is used to select a single activated DL TCI state. Alternatively, when a field includes a dedicated bit for a corresponding TCI codepoint that is set to a first value (e.g., bit=1), the MAC-CE indicates that TCI codepoint is used to select (1) paired activated DL and UL TCI states or (2) a single activated UL TCI state.

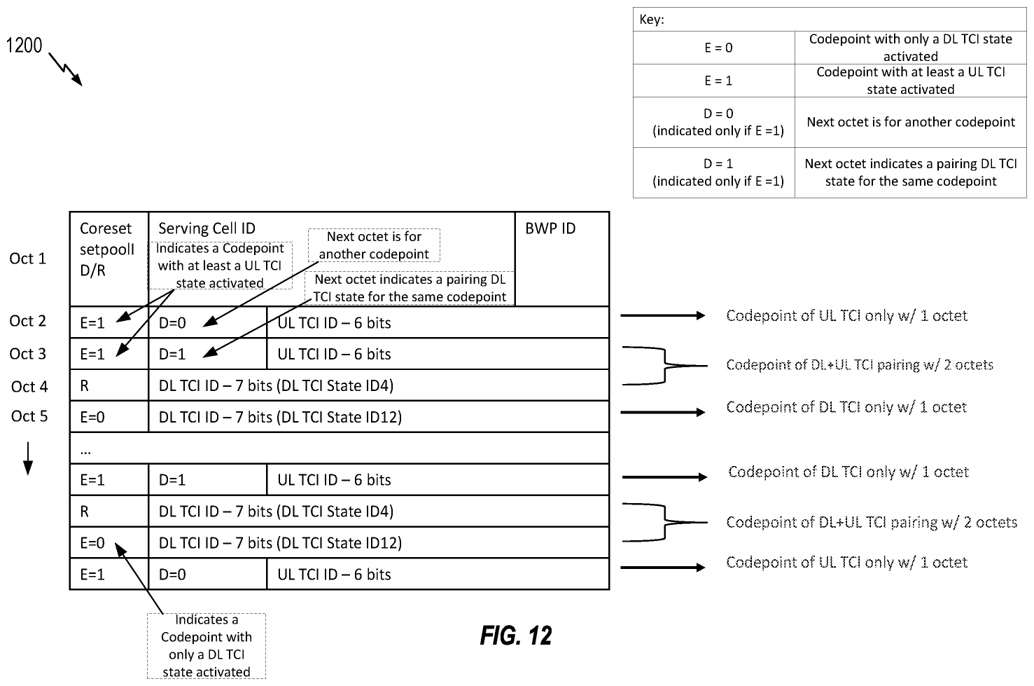

FIG. 12 illustrates an example MAC-CE 1200 having the second MAC-CE design described above, in accordance with certain aspects of the present disclosure. As shown in FIG. 12, example MAC-CE 1200 may have a plurality of fields (e.g., octets), for activating TCI states for up to eight codepoints. Different octets in the example MAC-CE 1200 may include a first dedicated bit for n codepoints, where n is an integer greater than zero. In the example illustrated in FIG. 12, the first dedicated bit may be represented by variable E. When a field in MAC-CE 1200 for a codepoint includes the first dedicated bit, E, set to a first value (e.g., E=0), the MAC-CE indicates the corresponding codepoint is used to select a single activated DL TCI state. Alternatively, when a field in MAC-CE 1200 for a codepoint includes the first dedicated bit, E, set to a second value (e.g., E=1), the MAC-CE indicates the corresponding codepoint is used to select (1) paired activated DL and UL TCI states or (2) a single activated UL TCI state.

For example, in octet 2, the first dedicated bit is set to 1 (e.g., E=1) indicating the corresponding codepoint for this octet is used to select a single activated UL TCI state. In octet 3, the first dedicated bit is also set to 1 (e.g., E=1); however, this bit indicates the corresponding codepoint for this octet is used to select paired activated DL and UL TCI states (because D=1). Alternatively, in octet 5 in MAC-CE 1200, the first dedicated bit is set to 0 (e.g., E=0) indicating the corresponding codepoint for this octet is used to select a single activated DL TCI state.

Further, in the second design of the MAC-CE, when a field in the MAC-CE includes a first dedicated bit for a TCI codepoint indicating the TCI codepoint is used to select a single activated DL TCI state, the field further comprises a TCI ID associated with the single activated DL TCI state. For example, in octet 5 in example MAC-CE 1200 illustrated in FIG. 12, the first dedicated bit is set to 0 (E=0), accordingly, octet 5 includes a TCI ID associated with the single activated DL TCI state. In certain aspects, the DL TCI ID included in the octet is seven bits (or in some cases, up to seven bits).

On the other hand, in the second design of the MAC-CE, when a field in the MAC-CE includes a first dedicated bit for a TCI codepoint indicating the TCI codepoint is used to select (1) paired activated DL and UL TCI states or (2) a single activated UL TCI state, the field includes a first TCI ID associated with a UL TCI state of the paired, activated DL and UL TCI states or the single activated UL TCI state. Further, the field includes a second dedicated bit that indicates whether the first TCI ID included in the field is associated with the single activated UL TCI state or one of the paired activated DL and UL TCI states. The remaining bits for an octet carrying a UL TCI ID may be reserved for other indications, since UL TCI ID may cost up to six bits only. In some aspects, one bit (i.e., D bit) for the octet carrying a UL TCI ID is used to indicate whether the codepoint is for paired activated DL and UL states.

For example, in octet 2 in example MAC-CE 1200 illustrated in FIG. 12, the first dedicated bit is set to 1, accordingly, octet 2 includes a TCI ID associated with the UL TCI state of paired, activated DL and UL TCI states or a single activated UL TCI state. In certain aspects, the UL TCI ID included in the octet is six bits (or in some cases, up to six bits). To indicate that this TCI ID is, in fact, associated with the UL TCI state of the single activated UL TCI state, the octet includes the second dedicated bit, D. The second dedicated bit being set to 0 (e.g., D=0), as illustrated in octet 2 in MAC-CE 1200, indicates this TCI ID is associated with a UL TCI state of the single activated UL TCI state, and accordingly, a next (consecutive) octet is used for another TCI codepoint.

As another example, in octet 3 in example MAC-CE 1200 illustrated in FIG. 12, the first dedicated bit is set to 1, accordingly, octet 3 includes a TCI ID associated with the UL TCI state of paired, activated DL and UL TCI states or a single activated UL TCI state. To indicate that this TCI ID is, in fact, associated with the paired, activated DL and UL TCI states, the octet includes the second dedicated bit, D. The second dedicated bit being set to 1 (e.g., D=1), as illustrated in octet 3 in MAC-CE 1200, indicates this TCI ID is associated with a UL TCI state of the paired, activated DL and UL TCI states, and accordingly, a next (consecutive) octet (e.g., a next (consecutive) field) is used for this TCI codepoint to indicate a second TCI ID associated with the other (e.g., associated with the DL TCI state) of the paired activated DL and UL TCI states. As shown in the example, because D is equal to 1 in octet 3, octet 4 includes the TCI ID associated with the DL TCI state of the paired, activated DL and UL TCI states. Accordingly, two octets may be used to indicate the TCI IDs associated with the paired, activated DL and UL TCI states.

Each of the first design and the second design of the compact MAC-CE (e.g., illustrated in FIGS. 10 and 11 and FIG. 12, respectively) may include a serving cell ID and/or a BWP ID. In certain aspects, the first design and the second design of the compact MAC-CE may include a CORESET pool ID/R (e.g., where mDCI based mTRP is configured).

### Example Operations

FIG. 13 is a flow diagram illustrating example operations 1300 for wireless communication by a user equipment (UE), in accordance with certain aspects of the present disclosure. Operations 1300 may be performed, for example, by UE 104 in wireless communication network 100 of FIG. 1.

Operations 1300 may be implemented as software components that are executed and run on one or more processors (e.g., controller/processor 280 of FIG. 2). Further, the transmission and reception of signals by the UE in operations 1300 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

Operations 1300 begin, at 1302, by the UE receiving signaling configuring the UE with a plurality of transmission configuration indication (TCI) states.

At 1304, the UE receives a medium access control (MAC) control element (CE) activating one or more TCI states, wherein the MAC-CE indicates whether one or more TCI codepoints are used to select a single activated downlink (DL) TCI state, a single activated uplink (UL) TCI state, or paired activated DL and UL TCI states.

At 1306, the UE receives a downlink control information (DCI) with a TCI field

At 1308, the UE determines at least one of a receive beam or a transmit beam to use for a transmission scheduled by the DCI, based on the TCI field and the MAC-CE.

FIG. 14 is a flow diagram illustrating example operations 1400 for wireless communication by a network entity, in accordance with certain aspects of the present disclosure. Operations 1400 may be performed, for example, by a base station (BS) (e.g., such as BS 102 in wireless communication network 100 of FIG. 1). Operations 1400 may be complementary to operations 1300 performed by the UE.

Operations 1400 may be implemented as software components that are executed and run on one or more processors (e.g., controller/processor 240 of FIG. 2). Further, the transmission and reception of signals by the network entity in operations 1400 may be enabled, for example, by one or more antennas (e.g., antennas 234 of FIG. 2). In certain aspects, the transmission and/or reception of signals by the network entity may be implemented via a bus interface of one or more processors (e.g., controller/processor 240) obtaining and/or outputting signals.

Operations 1400 begin, at 1402, by a network entity transmitting signaling configuring a UE with a plurality of TCI states.

At 1402, the network entity transmits a MAC-CE activating one or more TCI states, wherein the MAC-CE indicates whether one or more TCI codepoints are used to select a single activated DL TCI state, a single activated UL TCI state, or paired activated DL and UL TCI states.

At 1404, the network entity transmits a DCI with a TCI field.

At 1406, the network entity determines at least one of a receive beam or a transmit beam to use for a transmission scheduled by the DCI, based on the TCI field and the MAC-CE.

### Example Wireless Communication Devices

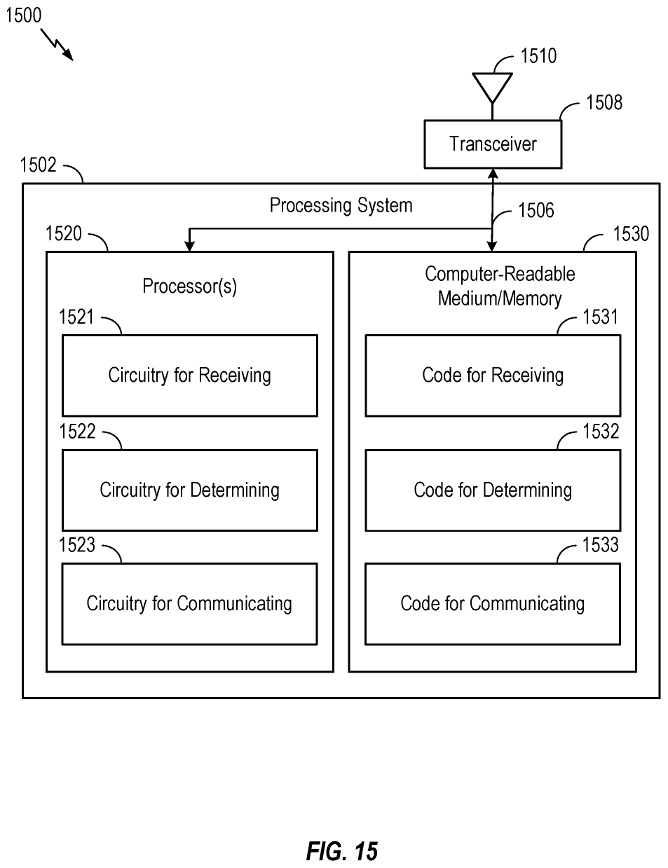

FIG. 15 depicts an example communications device 1500 that includes various components operable, configured, or adapted to perform operations for the techniques disclosed herein, such as the operations depicted and described with respect to FIGS. 9 and 13. In some examples, communications device 1500 may be a user equipment, such as UE 104 described, for example, with respect to FIGS. 1 and 2.

Communications device 1500 includes a processing system 1502 coupled to a transceiver 1508 (e.g., a transmitter and/or a receiver). Transceiver 1508 is configured to transmit (or send) and receive signals for the communications device 1500 via an antenna 1510, such as the various signals as described herein. Processing system 1502 may be configured to perform processing functions for communications device 1500, including processing signals received and/or to be transmitted by communications device 1500.

Processing system 1502 includes one or more processors 1520 coupled to a computer-readable medium/memory 1530 via a bus 1506. In certain aspects, computer-readable medium/memory 1530 is configured to store instructions (e.g., computer-executable code) that when executed by the one or more processors 1520, cause the one or more processors 1520 to perform the operations illustrated in FIGS. 9 and 13, or other operations for performing the various techniques discussed herein for activating transmission configuration indication (TCI) states.

In the depicted example, computer-readable medium/memory 1530 stores code 1531 for receiving (e.g., for receiving signaling configuring the UE with a plurality of TCI states, for receiving a MAC-CE activating one or more TCI states, wherein the MAC-CE indicates whether one or more TCI codepoints are used to select a single activated DL TCI state, a single activated UL TCI state, or paired activated DL and UL TCI states, for receiving a DCI with a TCI field, and/or for receiving a DL transmission), code 1532 for determining (e.g., for determining at least one of a receive beam or a transmit beam to use for a transmission scheduled by the DCI, based on the TCI field and the MAC-CE), and code 1533 for communicating (e.g., for communicating with a network entity).

In the depicted example, the one or more processors 1520 include circuitry configured to implement the code stored in the computer-readable medium/memory 1530, including circuitry 1521 for receiving (e.g., for receiving signaling configuring the UE with a plurality of TCI states, for receiving a MAC-CE activating one or more TCI states, wherein the MAC-CE indicates whether one or more TCI codepoints are used to select a single activated DL TCI state, a single activated UL TCI state, or paired activated DL and UL TCI states, for receiving a DCI with a TCI field, and/or for receiving a DL transmission), circuitry 1522 for determining (e.g., for determining at least one of a receive beam or a transmit beam to use for a transmission scheduled by the DCI, based on the TCI field and the MAC-CE), circuitry 1523 for communicating (e.g., for communicating with a network entity).

Various components of communications device 1500 may provide means for performing the methods described herein, including with respect to FIGS. 9 and 13.

In some examples, means for receiving (or means for obtaining) may include the transceivers 254 and/or antenna(s) 252 of UE 104 illustrated in FIG. 2 and/or transceiver 1508 and antenna 1510 of the communications device 1500 in FIG. 15.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for determining may include various processing system components, such as: the one or more processors 1520 in FIG. 15, or aspects of the UE 104 depicted in FIG. 2, including receive processor 258, transmit processor 264, TX MIMO processor 266, and/or controller/processor 280 (including TCI state activation component 281).

Notably, FIG. 15 is an example, and many other examples and configurations of communications device 1500 are possible.

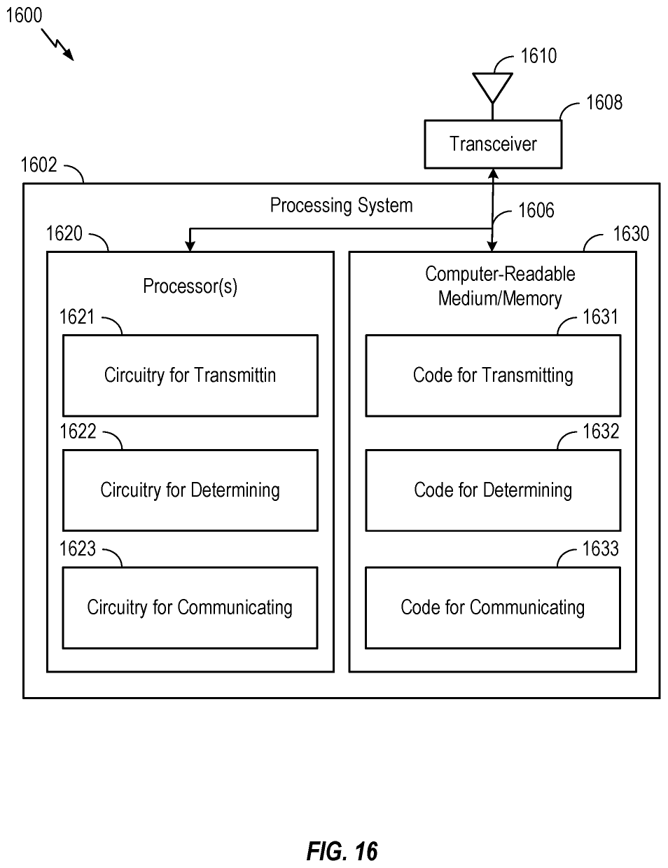

FIG. 16 depicts an example communications device 1600 that includes various components operable, configured, or adapted to perform operations for the techniques disclosed herein, such as the operations depicted and described with respect to FIGS. 9 and 14. In some examples, communications device 1600 may be a base station (BS), such as BS 102 as described, for example, with respect to FIGS. 1 and 2.

Communications device 1600 includes a processing system 1602 coupled to a transceiver 1608 (e.g., a transmitter and/or a receiver). Transceiver 1608 is configured to transmit (or send) and receive signals for the communications device 1600 via an antenna 1610, such as the various signals as described herein. Processing system 1602 may be configured to perform processing functions for communications device 1600, including processing signals received and/or to be transmitted by communications device 1600.

Processing system 1602 includes one or more processors 1620 coupled to a computer-readable medium/memory 1630 via a bus 1606. In certain aspects, computer-readable medium/memory 1630 is configured to store instructions (e.g., computer-executable code) that when executed by the one or more processors 1620, cause the one or more processors 1620 to perform the operations illustrated in FIGS. 9 and 14, or other operations for performing the various techniques discussed herein for activating TCI states.

In the depicted example, computer-readable medium/memory 1630 stores code 1631 for transmitting (e.g., for transmitting signaling configuring a UE with a plurality of TCI states, for transmitting a MAC-CE activating one or more TCI states, wherein the MAC-CE indicates whether one or more TCI codepoints are used to select a single activated DL TCI state, a single activated UL TCI state, or paired activated DL and UL TCI states, for transmitting a DCI with a TCI field, and/or for transmitting a DL transmission), code 1632 for determining (e.g., for determining at least one of a receive beam or a transmit beam to use for a transmission scheduled by the DCI, based on the TCI field and the MAC-CE), and code 1633 for communicating (e.g., for communicating with a UE).

In the depicted example, the one or more processors 1620 include circuitry configured to implement the code stored in the computer-readable medium/memory 1630, including circuitry 1621 for transmitting (e.g., for transmitting signaling configuring a UE with a plurality of TCI states, for transmitting a MAC-CE activating one or more TCI states, wherein the MAC-CE indicates whether one or more TCI codepoints are used to select a single activated DL TCI state, a single activated UL TCI state, or paired activated DL and UL TCI states, for transmitting a DCI with a TCI field, and/or for transmitting a DL transmission), circuitry 1622 for determining (e.g., for determining at least one of a receive beam or a transmit beam to use for a transmission scheduled by the DCI, based on the TCI field and the MAC-CE), and circuitry 1623 for communicating (e.g., for communicating with a UE).

Various components of communications device 1600 may provide means for performing the methods described herein, including with respect to FIGS. 9 and 14.

In some examples, means for transmitting or sending (or means for outputting for transmission) may include the transceivers 232 and/or antenna(s) 234 of BS 102 illustrated in FIG. 2 and/or transceiver 1608 and antenna 1610 of communications device 1600 in FIG. 16.

In some examples, means for receiving (or means for obtaining) may include the transceivers 232 and/or antenna(s) 234 of BS 102 illustrated in FIG. 2 and/or transceiver 1608 and antenna 1610 of communications device 1600 in FIG. 16.

In some examples, means for determining, means for configuring, means for updating, and means for starting may include various processing system components, such as: the one or more processors 1620 in FIG. 16, or aspects of the BS 102 depicted in FIG. 2, including receive processor 238, transmit processor 220, TX MIMO processor 230, and/or controller/processor 240 (including TCI state activation component 241).

Notably, FIG. 16 is an example, and many other examples and configurations of communications device 1600 are possible.

### Example Clauses

Implementation examples are described in the following numbered clauses:

Clause 1: A method for wireless communication by a user equipment (UE), comprising: receiving signaling configuring the UE with a plurality of transmission configuration indication (TCI) states; receiving a medium access control (MAC) control element (CE) activating one or more TCI states, wherein the MAC-CE indicates whether one or more TCI codepoints are used to select a single activated downlink (DL) TCI state, a single activated uplink (UL) TCI state, or paired activated DL and UL TCI states; receiving a downlink control information (DCI) with a TCI field; and determining at least one of a receive beam or a transmit beam to use for a transmission scheduled by the DCI, based on the TCI field and the MAC-CE.

Clause 2: The method of Clause 1, wherein the MAC-CE includes, a dedicated bit for each of the one or more TCI codepoints in a field in the MAC-CE, wherein each dedicated bit indicates whether a corresponding TCI codepoint is used to select a single activated DL TCI state, a single activated UL TCI state, or paired activated DL and UL TCI states.

Clause 3: The method of Clause 2, wherein when the dedicated bit for the corresponding TCI codepoint is set to a first value, that TCI codepoint is used to select the paired activated DL and UL TCI states.

Clause 4: The method of Clause 3, wherein, when the dedicated bit for the TCI codepoint is set to the first value, two consecutive fields of the MAC-CE indicate TCI identifiers (IDs) for the paired activated DL and UL TCI states.

Clause 5: The method of Clause 4, wherein the two consecutive fields comprise: a first field that indicates a DL TCI ID; and a second field that indicates UL TCI ID.

Clause 6: The method of Clause 5, wherein the DL TCI ID has more bits than the UL TCI ID.

Clause 7: The method of Clause 6, wherein each field of the two consecutive fields comprises a bit that indicates whether the TCI ID included in the field is associated with an activated DL TCI state or an activated UL TCI state of the paired activated DL and UL TCI states.

Clause 8: The method of any one of Clauses 3-7, wherein when the dedicated bit for the corresponding TCI codepoint is set to a second value, the MAC-CE indicates the TCI codepoint is used to select a single activated DL TCI state or a single activated UL TCI state.

Clause 9: The method of Clause 8, wherein, when the dedicated bit for the TCI codepoint is set to the second value, a single field for the corresponding TCI codepoint indicates a TCI ID for the single activated DL TCI state or the single activated UL TCI state.

Clause 10: The method of Clause 9, wherein the single field further comprises a special bit indicating whether the TCI ID included in the single field is associated with the activated DL TCI state or the activated UL TCI state.

Clause 11: The method of any one of Clauses 1-10, wherein: the MAC-CE includes a first dedicated bit for each of the one or more TCI codepoints; and the first dedicated bit, for each of the one or more TCI codepoints, is included in a separate field in the MAC-CE.

Clause 12: The method of Clause 11, wherein when a field comprises a first dedicated bit for a TCI codepoint of the one or more TCI codepoints that is equal to a first value, the MAC-CE indicates the TCI codepoint is used to select the single activated DL TCI state.

Clause 13: The method of Clause 12, wherein the field further comprises a TCI ID associated with the single activated DL TCI state.

Clause 14; The method of any one of Clauses 12-13, wherein when the field comprises a first dedicated bit for a TCI codepoint of the one or more TCI codepoints that is equal to a second value, the MAC-CE indicates the TCI codepoint is used to select: the paired activated DL and UL TCI states; or the single activated UL TCI state.

Clause 15: The method of Clause 14, wherein the field: indicates a first TCI ID associated with a UL TCI state of the paired, activated DL and UL TCI state or the single activated UL TCI state; and comprises a second dedicated bit that indicates whether the first TCI ID is associated with the single activated UL TCI state or one of the paired activated DL and UL TCI states.

Clause 16: The method of Clause 15, wherein when the second dedicated bit indicates the first TCI ID is associated with the paired activated DL and UL TCI states another field indicates a second TCI ID associated with the other of the paired activated DL and UL TCI states.

Clause 17: The method of any one of Clauses 1-16, wherein the UE is configured with: a single transmission reception point (sTRP) operation; or a multiple downlink control information (mDCI) based multiple TRP (mTRP) operation.

Clause 18: A method for wireless communication by a network entity, comprising: transmitting signaling configuring a user equipment (UE) with a plurality of transmission configuration indication (TCI) states; transmitting a medium access control (MAC) control element (CE) activating one or more TCI states, wherein the MAC-CE indicates whether one or more TCI codepoints are used to select a single activated downlink (DL) TCI state, a single activated uplink (UL) TCI state, or paired activated DL and UL TCI states; transmitting a downlink control information (DCI) with a TCI field; and determining at least one of a receive beam or a transmit beam to use for a transmission scheduled by the DCI, based on the TCI field and the MAC-CE.

Clause 19: The method of Clause 18, wherein the MAC-CE includes, a dedicated bit for each of the one or more TCI codepoints in a field in the MAC-CE, wherein each dedicated bit indicates whether a corresponding TCI codepoint is used to select a single activated DL TCI state, a single activated UL TCI state, or paired activated DL and UL TCI states.

Clause 20: The method of Clause 19, wherein when the dedicated bit for the corresponding TCI codepoint is set to a first value, that TCI codepoint is used to select the paired activated DL and UL TCI states.

Clause 21: The method of Clause 20, wherein, when the dedicated bit for the TCI codepoint is set to the first value, two consecutive fields of the MAC-CE indicate TCI identifiers (IDs) for the paired activated DL and UL TCI states.

Clause 22: The method of Clause 21, wherein the two consecutive fields comprise: a first field that indicates a DL TCI ID; and a second field that indicates UL TCI ID.

Clause 23: The method of Clause 22, wherein the DL TCI ID has more bits than the UL TCI ID.

Clause 24; The method of Clause 23, wherein each field of the two consecutive fields comprises a bit that indicates whether the TCI ID included in the field is associated with an activated DL TCI state or an activated UL TCI state of the paired activated DL and UL TCI states.

Clause 25: The method of any one of Clauses 20-24, wherein when the dedicated bit for the corresponding TCI codepoint is set to a second value, the MAC-CE indicates the TCI codepoint is used to select a single activated DL TCI state or a single activated UL TCI state.

Clause 26: The method of Clause 25, wherein, when the dedicated bit for the TCI codepoint is set to the second value, a single field for the corresponding TCI codepoint indicates a TCI ID for the single activated DL TCI state or the single activated UL TCI state.

Clause 27: The method of Clause 26, wherein the single field further comprises a special bit indicating whether the TCI ID included in the single field is associated with the activated DL TCI state or the activated UL TCI state.

Clause 28: The method of any one of Clauses 18-27, wherein: the MAC-CE includes a first dedicated bit for each of the one or more TCI codepoints; and the first dedicated bit, for each of the one or more TCI codepoints, is included in a separate field in the MAC-CE.

Clause 29: The method of Clause 28, wherein when a field comprises a first dedicated bit for a TCI codepoint of the one or more TCI codepoints that is equal to a first value, the MAC-CE indicates the TCI codepoint is used to select the single activated DL TCI state.

Clause 30: The method of Clause 29, wherein the field further comprises a TCI ID associated with the single activated DL TCI state.

Clause 31: The method of any one of Clauses 29-30, wherein when the field comprises a first dedicated bit for a TCI codepoint of the one or more TCI codepoints that is equal to a second value, the MAC-CE indicates the TCI codepoint is used to select: the paired activated DL and UL TCI states; or the single activated UL TCI state.

Clause 32: The method of Clause 31, wherein the field: indicates a first TCI ID associated with a UL TCI state of the paired, activated DL and UL TCI state or the single activated UL TCI state; and comprises a second dedicated bit that indicates whether the first TCI ID is associated with the single activated UL TCI state or one of the paired activated DL and UL TCI states.

Clause 33: The method of Clause 32, wherein when the second dedicated bit indicates the first TCI ID is associated with the paired activated DL and UL TCI states another field indicates a second TCI ID associated with the other of the paired activated DL and UL TCI states.

Clause 34: The method of any one of Clauses 18-33, wherein the UE is configured with: a single transmission reception point (sTRP) operation; or a multiple downlink control information (mDCI) based multiple TRP (mTRP) operation.

Clause 35: An apparatus, comprising: a memory comprising computer-executable instructions; one or more processors configured to execute the computer-executable instructions and cause the processing system to perform a method in accordance with any one of Clauses 1-34.

Clause 36: An apparatus, comprising means for performing a method in accordance with any one of Clauses 1-34.

Clause 37: A non-transitory computer-readable medium comprising computer-executable instructions that, when executed by one or more processors of a processing system, cause the processing system to perform a method in accordance with any one of Clauses 1-34.

Clause 38: A computer program product embodied on a computer-readable storage medium comprising code for performing a method in accordance with any one of Clauses 1-34.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as BS 180 (e.g., a gNB) may operate in a traditional sub-6 GHz spectrum, in millimeter wave (mmWave) frequencies, and/or near mmWave frequencies in communication with the UE 104. When the BS 180 operates in mmWave or near mm Wave frequencies, the BS 180 may be referred to as an mmWave base station.

The communication links 120 between BSs 102 and, for example, UEs 104, may be through one or more carriers. For example, BSs 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A, 3B, 3C, and 3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (u) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The PDCCH carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of providing UE capability information for one or more TCI beam indication types in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus, comprising:
a memory comprising executable instructions; and
one or more processors configured to execute the executable instructions and cause the apparatus to:
receive signaling configuring the apparatus with a plurality of transmission configuration indication (TCI) states;
receive a medium access control (MAC) control element (CE) activating one or more TCI states, wherein the MAC-CE indicates whether one or more TCI codepoints are used to select a single activated downlink (DL) TCI state, a single activated uplink (UL) TCI state, or paired activated DL and UL TCI states;
receive a downlink control information (DCI) with a TCI field; and
determine at least one of a receive beam or a transmit beam to use for a transmission scheduled by the DCI, based on the TCI field and the MAC-CE.

2. The apparatus of claim 1, wherein the MAC-CE includes, a dedicated bit for each of the one or more TCI codepoints in a field in the MAC-CE, wherein each dedicated bit indicates whether a corresponding TCI codepoint is used to select a single activated DL TCI state, a single activated UL TCI state, or paired activated DL and UL TCI states.

3. The apparatus of claim 2, wherein when the dedicated bit for the corresponding TCI codepoint is set to a first value, that TCI codepoint is used to select the paired activated DL and UL TCI states.

4. The apparatus of claim 3, wherein, when the dedicated bit for the TCI codepoint is set to the first value, two consecutive fields of the MAC-CE indicate TCI identifiers (IDs) for the paired activated DL and UL TCI states.

5. The apparatus of claim 4, wherein the two consecutive fields comprise:
a first field that indicates a UL TCI ID; and
a second field that indicates a DL TCI ID.

6. The apparatus of claim 5, wherein the DL TCI ID has more bits than the UL TCI ID.

7. The apparatus of claim 6, wherein each field of the two consecutive fields comprises a bit that indicates whether the TCI ID included in the field is associated with an activated DL TCI state or an activated UL TCI state of the paired activated DL and UL TCI states.

8. The apparatus of claim 3, wherein when the dedicated bit for the corresponding TCI codepoint is set to a second value, the MAC-CE indicates the TCI codepoint is used to select a single activated DL TCI state or a single activated UL TCI state.

9. The apparatus of claim 8, wherein, when the dedicated bit for the TCI codepoint is set to the second value, a single field for the corresponding TCI codepoint indicates a TCI ID for the single activated DL TCI state or the single activated UL TCI state.

10. The apparatus of claim 9, wherein the single field further comprises a bit indicating whether the TCI ID included in the single field is associated with the activated DL TCI state or the activated UL TCI state.

11. The apparatus of claim 1, wherein:
the MAC-CE includes a first dedicated bit for each of the one or more TCI codepoints; and
the first dedicated bit, for each of the one or more TCI codepoints, is included in a separate field in the MAC-CE.

12. The apparatus of claim 11, wherein when a field comprises a first dedicated bit for a TCI codepoint of the one or more TCI codepoints that is equal to a first value, the MAC-CE indicates the TCI codepoint is used to select the single activated DL TCI state.

13. The apparatus of claim 12, wherein the field further comprises a TCI ID associated with the single activated DL TCI state.

14. The apparatus of claim 12, wherein when the field comprises a first dedicated bit for a TCI codepoint of the one or more TCI codepoints that is equal to a second value, the MAC-CE indicates the TCI codepoint is used to select:
the paired activated DL and UL TCI states; or
the single activated UL TCI state.

15. The apparatus of claim 14, wherein the field:
indicates a first TCI ID associated with a UL TCI state of the paired, activated DL and UL TCI states or the single activated UL TCI state; and
comprises a second dedicated bit that indicates whether the first TCI ID is associated with the single activated UL TCI state or one of the paired activated DL and UL TCI states.

16. The apparatus of claim 15, wherein when the second dedicated bit indicates the first TCI ID is associated with the paired activated DL and UL TCI states another field indicates a second TCI ID associated with the other of the paired activated DL and UL TCI states.

17. The apparatus of claim 1, wherein when the UE is configured with:
a single transmission reception point (sTRP) operation; or
a multiple downlink control information (mDCI) based multiple TRP (mTRP) operation.

18. An apparatus, comprising:
a memory comprising executable instructions; and
one or more processors configured to execute the executable instructions and cause the apparatus to:
transmit signaling configuring a user equipment (UE) with a plurality of transmission configuration indication (TCI) states;
transmit a medium access control (MAC) control element (CE) activating one or more TCI states, wherein the MAC-CE indicates whether one or more TCI codepoints are used to select a single activated downlink (DL) TCI state, a single activated uplink (UL) TCI state, or paired activated DL and UL TCI states;
transmit a downlink control information (DCI) with a TCI field; and
determine at least one of a receive beam or a transmit beam to use for a transmission scheduled by the DCI, based on the TCI field and the MAC-CE.

19. The apparatus of claim 18, wherein the MAC-CE includes, a dedicated bit for each of the one or more TCI codepoints in a field in the MAC-CE, wherein each dedicated bit indicates whether a corresponding TCI codepoint is used to select a single activated DL TCI state, a single activated UL TCI state, or paired activated DL and UL TCI states.

20. The apparatus of claim 19, wherein when the dedicated bit for the corresponding TCI codepoint is set to a first value, that TCI codepoint is used to select the paired activated DL and UL TCI states.

21. The apparatus of claim 20, wherein, when the dedicated bit for the TCI codepoint is set to the first value, two consecutive fields of the MAC-CE indicate TCI identifiers (IDs) for the paired activated DL and UL TCI states.

22. The apparatus of claim 21, wherein the two consecutive fields comprise:
a first field that indicates a UL TCI ID; and
a second field that indicates a DL TCI ID.

23. The apparatus of claim 22, wherein the DL TCI ID has more bits than the UL TCI ID.

24. The apparatus of claim 23, wherein each field of the two consecutive fields comprises a bit that indicates whether the TCI ID included in the field is associated with an activated DL TCI state or an activated UL TCI state of the paired activated DL and UL TCI states.

25. The apparatus of claim 20, wherein when the dedicated bit for the corresponding TCI codepoint is set to a second value, the MAC-CE indicates the TCI codepoint is used to select a single activated DL TCI state or a single activated UL TCI state.

26. The apparatus of claim 25, wherein, when the dedicated bit for the TCI codepoint is set to the second value, a single field for the corresponding TCI codepoint indicates a TCI ID for the single activated DL TCI state or the single activated UL TCI state.

27. The apparatus of claim 26, wherein the single field further comprises a bit indicating whether the TCI ID included in the single field is associated with the activated DL TCI state or the activated UL TCI state.

28. The apparatus of claim 18, wherein:
the MAC-CE includes a first dedicated bit for each of the one or more TCI codepoints; and
the first dedicated bit, for each of the one or more TCI codepoints, is included in a separate field in the MAC-CE.

29. A method for wireless communication by a user equipment (UE), comprising:
receiving signaling configuring the UE with a plurality of transmission configuration indication (TCI) states;
receiving a medium access control (MAC) control element (CE) activating one or more TCI states, wherein the MAC-CE indicates whether one or more TCI codepoints are used to select a single activated downlink (DL) TCI state, a single activated uplink (UL) TCI state, or paired activated DL and UL TCI states;
receiving a downlink control information (DCI) with a TCI field; and
determining at least one of a receive beam or a transmit beam to use for a transmission scheduled by the DCI, based on the TCI field and the MAC-CE.

30. A method for wireless communication by a network entity, comprising:
transmitting signaling configuring a user equipment (UE) with a plurality of transmission configuration indication (TCI) states;
transmitting a medium access control (MAC) control element (CE) activating one or more TCI states, wherein the MAC-CE indicates whether one or more TCI codepoints are used to select a single activated downlink (DL) TCI state, a single activated uplink (UL) TCI state, or paired activated DL and UL TCI states;
transmitting a downlink control information (DCI) with a TCI field; and
determining at least one of a receive beam or a transmit beam to use for a transmission scheduled by the DCI, based on the TCI field and the MAC-CE.
